(19) United States
(12) Patent Application Publication
(10) Pub. No.: US 2024/0033711 A1
(43) Pub. Date: Feb. 1, 2024

(54) CHROMATOGRAPHIC MATERIAL AND METHOD OF PRODUCING SAME

(71) Applicant: Sartorius Stedim Biotech GmbH, Göttingen (DE)

(72) Inventors: Adrian Ley, Göttingen (DE); Rebecca Petersen, Schifferstadt (DE); Florian Taft, Hannover (DE); Patrick Adametz, Göttingen (DE); Axel Thiefes, Hardegsen (DE); Kathrin Toeppner, Göttingen (DE); Stella Weber, Göttingen (DE); Nils Gehrmann, Göttingen (DE); Franziska Hagemann, Göttingen (DE); Volkmar Thom, Göttingen (DE)

(21) Appl. No.: 18/258,672

(22) PCT Filed: Dec. 21, 2021
(86) PCT No.: PCT/EP2021/087131

§ 371 Date: Jun. 21, 2023

(30) Foreign Application Priority Data
Dec. 22, 2020 (EP) 20216353.1

(51) Int. Cl. B01J 20/24; B01J 20/30; B01J 20/28; B01J 20/285

(52) U.S. Cl. CPC B01J 20/24; B01J 20/3007; B01J 20/28033; B01J 20/285; B01J 20/28085

(57) ABSTRACT

The present invention relates to a chromatographic material comprising a polymer network material-based self-supporting bi-continuous separation matrix for adsorptive material separation in liquid media, and a method of producing the chromatographic material comprising a polymer network material-based self-supporting bi-continuous separation matrix.

The present invention relates to a chromatographic material comprising a polymer network material-based self-supporting bi-continuous separation matrix for adsorptive material separation in liquid media, and a method of producing the chromatographic material comprising a polymer network material-based self-supporting bi-continuous separation matrix.

Chromatography is a general separation technique that uses the distribution of the molecules of interest between a stationary phase and a mobile phase for molecular separation. The stationary phase refers to a porous media and imbibed immobile solvent. Columns with associated end caps, fittings and tubing are the most common configuration, with the media packed into the tube or column. The mobile phase is pumped through the column. The sample is introduced at one end of the column, and the various components (target substances and contaminants) interact with the stationary phase and are adsorbed to or in the media or traverse the column at different velocities. The separated components are collected or detected at the other end of the column. Adsorbed components may be released in a separate step by pumping an eluant solvent through the column. Chromatographic methods include, among other methods, gel chromatography, ion exchange chromatography, hydrophobic interaction chromatography, reverse phase chromatography, affinity chromatography, immunoadsorption chromatography, lectin affinity chromatography, ion affinity chromatography and other such well-known chromatographic methods.

Polysaccharide gels are known to play an important role for the manufacture of materials for separation of mixtures of biomolecules. Among the characteristics making these gels especially interesting can be mentioned their inertness in contact with proteins and other biomolecules and their porous structure. A further important property is their resistance against alkaline conditions, which is of great importance in large scale separation processes requiring frequent regeneration/sterilization of the gel.

Polysaccharide gels are used for various types of chromatography. One such example is gel filtration, whereby the sample constituents are size fractionated. This is an application where the inertness is of crucial importance, since any interaction between the gel material as such and the sample molecules makes the separation less effective and might even completely destroy the result. Another example of a commercially important chromatographic technique is ion exchange chromatography. Several materials for ion exchange chromatography are derived from dextran, agarose or cellulose. The choice of polysaccharide gels as the carrier matrix is based on their inertness and a well-established derivatization chemistry for the introduction of ion exchange groups. A further example is affinity chromatography. Again, polysaccharide gels are preferred in many applications due to the number of convenient techniques available for introducing the affinity ligands and due to the minimum of unspecific binding of biomolecules.

Polysaccharide gels may be produced in various shapes, for instance more or less regular beads like spheres, but also in the shape of membranes, etc., and can be used as a base matrix for the manufacture of chromatographic media, and as a carrier matrix in general for various biomolecules like cells, enzymes, antibodies etc.

Polysaccharide gels typically have small diameter diffusion pores in a molecular dimension of about 10 to 500 nm, which may only be reached by components (target substances and/or contaminants) in the mobile phase via diffusion. In order to effectively transport binding components to the gel, a convective phase surrounds the polysaccharide gel, forming an interface between the convective phase and the diffusive gel phase. Polysaccharide gels are most widely used in the shape of particles of approximately 50 to 100 μm in diameter. These particles are packed into a chromatographic column where the interstitial phase between the particles forms the convective phase that allows to rapidly transport molecules through the column and to the surface of the beads, i.e. to the surface of the polysaccharide gel. Besides forming the convective phase that interfaces the diffusive phase by packing beads into a column, the convective phase can also be formed by large diameter convective pores (also called “flow through pores” or “macropores”) which may provide flow passages or channels, through the gel. The solidified polysaccharide gel forms so-called “bridges” around the large diameter convective pores. The small diameter diffusion pores are within said bridges formed by the solidified polysaccharide. When such porous polysaccharide gels are packed in a chromatographic column and a liquid flow is applied through the column, the flow will mainly pass through the gel via the large diameter convective pores. The components (target substances and/or contaminants) to be separated are thus transported also to the inner parts of the gel by convective flow, which is a much faster way of transportation than diffusion. Therefore, only short distances have to be covered by diffusion in such porous polysaccharide gels. FIG. 1 shows a comparison of the convective and diffusional flow paths in polysaccharide particles and polysaccharide membranes.

It is known from e.g. U.S. Pat. No. 4,935,365 A that polysaccharides can be produced to contain macropores. A gel as described therein has a considerably larger surface area due to the macropores, a fact which increases its use in some applications, like cell culture and also in certain chromatographic techniques. The macropores in U.S. Pat. No. 4,935,365 A are, however, not interconnected and there is accordingly no through flow via these pores.

The smaller the diameter of the pores is, the smaller also the “bridges”/diffusive path length (which is half the length of the bridge diameter) is. The correlation between large diameter convective pores and bridges is accessible through geometrical considerations. In particular, the bigger the large diameter convective pores become with a constant pore volume fraction (convective porosity), the bigger the bridges have to become because the bridges just represent the space between the large diameter convective pores. If there are less large diameter convective pores (bigger pores with constant volume fraction also means less pores) the space between them has to grow. Therefore, in case a porous polysaccharide material has rather small large diameter convective pores, the diffusive path length within the bridges is also rather small and the diffusive pores within the porous bridges are accessible within very short diffusion times. This geometrically given correlation indicates strongly why a smaller pore size is advantageous for a chromatographic operation within such materials.

In the production of porous polysaccharide materials having two types of pores, i.e. small diameter diffusion pores and large diameter convective pores, the pore size of the convective pores (and thus also the bridge size) and structure morphology of the polysaccharide material are influenced by the following interrelated process parameters:
volume ratio (vol %) of surfactant
type of surfactant
volume ratio (vol %) of organic solvent (water immiscible organic phase)
volume of the aqueous gelling phase
type of organic solvent (single solvent or mixture of solvents)
concentration of polysaccharide in the aqueous gelling phase
stirring speed during mixing of the water-containing solution of the polysaccharide with an essentially water immiscible organic phase.

U.S. Pat. No. 5,723,601 A describes a porous polysaccharide material having two types of pores, i.e. small diameter diffusion pores and large diameter convective pores. In the Examples of U.S. Pat. No. 5,723,601 A, porous polysaccharide materials are produced in which the convective pores have a minimum diameter of 10 μm. Although U.S. Pat. No. 5,723,601 A also mentions convective pore diameters as small as 0.5 μm, it is not possible from a technical point of view to produce porous polysaccharide materials having large diameter convective pores with a diameter of less than 10 μm by the methods taught by U.S. Pat. No. 5,723,601 A, since U.S. Pat. No. 5,723,601 A does not describe suitable combinations of the polysaccharide concentration, the surfactant (type and concentration) and the organic solvent to produce porous polysaccharide materials having such small convective pores. In particular, U.S. Pat. No. 5,723,601 A teaches that smaller convective pores can be obtained in case of using a smaller surfactant concentration at a higher stirrer speed. However, when lowering the surfactant concentration at the highest possible stirrer speed and under the experimental conditions described in U.S. Pat. No. 5,723,601 A, the minimum convective pore diameter that can be obtained for convective pores which are interconnected is about 6.5 μm. When the surfactant concentration is further lowered under the experimental conditions described in U.S. Pat. No. 5,723,601 A, the obtained pore structure is not an interconnected pore structure, but a closed-cell foam structure, which will be demonstrated hereinafter. Foams consist of partially more or less connected globular structures as convective phase (macropores) between the diffusive phase, i.e. the macropores are not interconnected. The inherently resulting poorer connectivity results in structures with a very low permeability at comparable pore size (i.e. the diameter of the globular structure), since there is no through flow via these pores. Therefore, foam structures can only be traversed in a very inhomogeneous and inadequate manner, which results in disadvantages in the homogeneous distribution of fluid in the chromatographic medium and, in addition to the lower permeability, in disadvantages in the dynamic binding.

U.S. Pat. No. 7,479,233 B2 describes a porous coated medium for adsorption or chromatography based separations comprising a base substrate, the base substrate being a porous non-woven fabric, self-supporting structure, and one or more porous coatings being formed of a polysaccharide on at least a portion of all surfaces of the substrate. In the production method of the coated media, the inert substrate is first coated with a polysaccharide layer, and then the coated substrate is subjected to a gelling agent such that the polysaccharide forms a porous hydrogel coating. Due to this specific production method (coating and afterwards gelling), the inert substrate constitutes the structure of the porous hydrogel coating, i.e. the pore structure of the hydrogel coating follows the pore structure of the inert substrate. Since the presence of a large amount of inert substrate is needed as a support for the porous coating (which acts as the chromatography medium for binding target compounds and/or contaminants), the possible amount of porous binding phase is massively restricted, and the possible binding capacity of the adsorption medium is negatively affected.

U.S. Pat. No. 8,298,657 B2 describes a functional, porous, interpenetrating polymer network (IPN) including a first polymer network in the form of a porogenic support fabric composed of linear polymers in the form of a pre-formed network comprising non-woven fibers, and a second polymer network synthesized, gelated, and/or cross-linked in the presence of the first polymer network. In the production of the IPN, a portion of the fibers of the first polymer network are removed to form pores that are substantially cylindrical in shape since the removed fibers have a minimum length of about 1.0 millimeter. Like in U.S. Pat. No. 7,479,223 B2, the mandatory presence of fleece fibers also limits the maximum possible amount of binding polymer and has a negative effect on the binding capacity. In addition, the use of non-woven fibers to dissolve them as a process for forming cylindrical pores causes a significantly higher tortuosity which, as a person skilled in the art knows, results in lower permeability at comparable pore size diameters.

US 2011/0120947 A1 describes a crosslinked cellulose hydrate membrane used for chromatography processes, the crosslinked cellulose hydrate membrane having a porous double structure consisting of “micropores” and “ultrapores”. The membrane of US 2011/0120947 A1 mandatorily consists of cellulose acetate which, in the manufacturing process, leads through swelling and saponification of this material to a material that has convective and diffusive components. However, these materials consisting of regenerated cellulose are not self-gelling materials or phases that are constituted by self-gelling materials, and the diffusive pores that are present in such materials are very small and difficult to control.

U.S. Pat. No. 7,316,919 B2 describes a composite material of a porous support and a non-self supporting crosslinked gel derived from a radical polymerization reaction that contains “micropores” between 10 and 3000 nm and is located inside the pores of the support structure. However, these materials are limited in their maximum gel porosity and convective porosity. In addition, the porosity and pore size distribution in the composite material is hard to control both due to the nature of synthetic polymer gels. Like in U.S. Pat. No. 7,479,223 B2 and US 8,298,657 B2 described above, the presence of a support material significantly reduces the number of binding polymers, thereby massively impairing both permeability and possible binding capacity of such composite materials.

In view of the above, the technical problem underlying the present invention is to provide a chromatographic material with which chromatographic processes can be carried out more quickly and more efficiently, as well as to provide a method of producing said chromatographic material.

The solution to the above technical problem is achieved by providing the embodiments characterized in the claims.

In particular, there is provided a chromatographic material comprising a polymer network material-based self-supporting bi-continuous separation matrix comprising a first continuous phase and a second continuous phase, the chromatographic material optionally comprising a third inert phase, wherein the first continuous phase is a portion of the matrix which is formed by a self-gelled polysaccharide and wherein the second continuous phase is a portion of the matrix which defines non-cylindrical large diameter continuously connected convective pores in-between the first continuous phase, wherein the large diameter continuously connected convective pores have a median pore diameter of from 0.1 μm to 6.0 μm, and wherein the third inert phase does not constitute the structure of the second continuous phase.

The chromatographic material of the present invention comprises a separation matrix which is a self-supporting separation matrix. As used herein, the expression “self-supporting separation matrix” means that the separation matrix, due to its continuous connected gel structure, is inherently dimensionally stable, and can be generated and handled without the need of an inert substrate as a supporting substrate. This does not exclude the possibility to introduce a third inert phase as a reinforcing substrate if needed for further enhanced mechanical strength or elevated ease of handling or integration into a chromatographic device.

The self-supporting matrix of the chromatographic material of the present invention has a bi-continuous structure. As used herein, the expressions “bi-continuous” or “bicontinuous” mean that the separation matrix has a structure which comprises two voluminous (mostly) continuous phases that penetrate each other and are each (mostly) continuous (interconnected) in themselves. Thus, at least 90%, preferably at least 95%, and more preferably at least 98% of the volume elements within a (mostly) continuous phase can be reached from any point within this voluminous phase without leaving this phase. According to a particular preferred embodiment of the present invention, every volume element within a continuous phase can be reached from any point within this voluminous phase without leaving this phase. This can be seen in 3D structures of the separation matrix by inspecting a volume element visually of at least 64*10³ μm³. How to obtain 3D structures by Confocal Laser Scanning Microscopy is known to a person skilled in the art of the present technical field and an example thereof can be found in the scientific publication of Ley et. al, Journal of Membrane Science, Volume 564, 2018, Pages 543-551 (Page 545).

The first continuous phase of the separation matrix of the chromatographic material of the present invention is a portion of the matrix which is formed by a self-gelled polysaccharide, i.e. the first continuous phase comprises at least 90% of a self-gelled polysaccharide, preferably at least 95%, more preferably at least 98%, and more preferably at least 99%. According to a particularly preferred embodiment, the first continuous phase comprises 100% of a self-gelled polysaccharide, i.e. the first continuous phase consists of a self-gelled polysaccharide. The first continuous phase typically has small diameter diffusion pores in a molecular dimension of about 10 to 500 nm. The first phase is (mostly) continuously connected, i.e. at least 90%, preferably at least 95%, and more preferably at least 98% of the volume elements within the first phase can be reached from any point within the first phase without leaving the first phase. According to a particular preferred embodiment of the present invention, every volume element within the first phase can be reached from any point within the first phase without leaving the first phase.

As used herein, “gelling” is the process in which a polymer solution, particularly a polysaccharide solution, solidifies and therefore forms a polymer gel in which a solvent (such as e.g. water or glycerin) is filling the porous space inside the polymer gel. The solvent may improve the (storage) stability of the gel. For a self-gelling/self-gelled polymer/polysaccharide gel, no external or additional polymer or monomer or cross linker has to be involved to form the physical or covalent bonds that are leading to the polymer/polysaccharide gel formation.

The self-gelled polysaccharide (having small diameter diffusion pores) is porous, i.e. the polysaccharide has at least 20% porosity. The pores within the self-gelled polysaccharide are small diameter diffusion pores typical to polysaccharide gels. Porosity as used herein is defined as the volume of the material filled by a gas or a liquid (V_{gas or liquid or both in parts}) divided by the whole volume of the material including the solid volume (V_{total gas+liquid+solid}).

$$porosity = \frac{{V}_{gas or liquid or both in parts}}{{V}_{total gas + liquid + solid}}$$

According to a preferred embodiment of the present invention, the self-gelling/self-gelled polysaccharide is one or more selected from the group consisting of agarose, agar, agaropectin, kappa-carrageenan, iota-carrageenan, lambda-carrageenan, gellan gum, amylose, curdlan, alginate and rhamsan gum. These self-gelling/self-gelled polysaccharides advantageously allow to form a separation matrix having small pores and large pores, i.e. a structure having small diameter diffusion pores and large diameter convective pores (double porous structure), by using a single emulsion during preparation. Moreover, said hydrophilic polysaccharides exhibit low non-specific binding. According to a particularly preferred embodiment of the present invention, the self-gelling/self-gelled porous polysaccharide is agarose.

The second continuous phase of the separation matrix of the chromatographic material of the present invention is a portion of the matrix which defines non-cylindrical large diameter continuously connected convective pores in-between the first continuous phase. The non-cylindrical large diameter convective pores are (mostly) continuously connected (interconnected), i.e. at least 90%, preferably at least 95%, and more preferably at least 98% of the pores of the non-cylindrical large diameter convective pores can be reached from any point of another pore of the non-cylindrical large diameter convective pores by moving only through non-cylindrical large diameter convective pores. According to a particularly preferred embodiment of the present invention, any pore of the non-cylindrical large diameter convective pores can be reached from any point of another pore of the non-cylindrical large diameter convective pores by moving only through non-cylindrical large diameter convective pores. The non-cylindrical large diameter convective pores are in-between the first continuous phase (the self-gelled polysaccharide), i.e. the self-gelled polysaccharide forms porous gel bridges around the non-cylindrical large diameter convective pores. Said large diameter convective pores are non-cylindrical, i.e. said pores are substantially spherical wherein parts of the substantially spherical pores typically overlap in order to form a continuous convective pore structure.

According to the present invention, the non-cylindrical large diameter continuously connected convective pores have a median pore diameter of from 0.1 μm to 6.0 μm. Heretofore, no chromatographic material comprising a polymer network material-based self-supporting bi-continuous separation matrix without an inert phase as supporting material for constituting the second continuous (pore) phase of the separation matrix has been described in the art that has such small non-cylindrical continuously connected large diameter convective pores, since no suitable method for preparing such chromatographic material was known. The median pore diameter may e.g. be determined as the median value of all pore data from the method in the scientific publication of Ley et. al, Journal of Membrane Science, Volume 564, 2018, Pages 543-551 (Page 546-548). Preferably, the median pore diameter is from 0.5 μm to 5.0 μm, most preferred from 1.0 μm to 3.0 μm. Since the non-cylindrical continuously connected large diameter convective pores have a median pore diameter within the above range, the diffusive path length is also small (cf. FIG. 4) and the small diameter diffusive pores within the porous bridges are accessible within very short diffusion times, advantageously allowing to operate chromatographic processes very quickly and efficiently.

Although the separation matrix of the chromatographic material of the present invention is a self-supporting inherently stable separation matrix, the chromatographic material of the present invention may also optionally comprise a third inert phase as a reinforcing material to even more strengthen the chromatographic material against external stresses such as pressure or damaging radiation. In case a third inert phase is present as a reinforcing material, the third inert phase does not constitute the structure of the second continuous phase of the separation matrix. That is, the third inert phase is randomly distributed in the polymer network material-based self-supporting bi-continuous separation matrix independently from the structure of the second continuous phase, and the pore structure of the second continuous phase does not follow the structure of the inert phase like in the chromatographic materials described in U.S. Pat. No. 7,479,233 B2.

The third inert phase as an additional reinforcing material for the separation matrix in the chromatographic material of the present invention may facilitate production and use of the chromatography material due to increasing the stability of the separation matrix. The third inert phase acting as a reinforcing material is not particularly limited and may e.g. be fleece materials or nonwovens (drylaid, wetlaid, spunlaid, meltblown), wovens, fabrics, mesh fabrics, open cell foams, reticulated foams or other permeable porous materials. Commercially available reinforcing materials are e.g. nonwoven Novatexx 2465 from Freudenberg; nonwoven Reemay 2016 from Berry, and mesh fabric Sefar 07-200/35.

According to a preferred embodiment of the present invention, the chromatographic material additionally comprising a third inert phase has a ratio of the volume of the third inert phase to the total volume of the chromatographic material including the third inert phase of from 0.03 to 0.60, more preferred of from 0.05 to 0.40, most preferred of from 0.08 to 0.25. As used herein, the “volume of the third inert phase” (V) is the volume that is taken by the third inert phase. By knowing the density (φ) of the underlying material, the volume of the third inert phase (V) can be calculated from the mass (m) thereof:

$${V}_{third inert phase} = \frac{{m}_{third inert phase}}{{φ}_{third inert phase}}$$

As used herein, the “total volume of the chromatographic material including the third inert phase” is the total volume of the physical dimensions of the chromatographic material including the third inert phase volume and the volume of the two continuous phases. Said total volume can be determined by measuring the outer dimensions like diameter and thickness of the chromatographic material, depending on its macroscopic appearance.

If the aforementioned volume ratio is below the above range, the stability enhancing effect of the third inert phase acting as reinforcing material may be diminished. If the aforementioned volume ratio is above the aforementioned range, the binding capacity and the permeability of the chromatographic material will be diminished.

The third inert phase acting as a reinforcing material preferably has one or more of the following properties:
base stability, i.e. the reinforcing material resists 0.1N NaOH for at least 5 h, more preferably for at least 24 h, without significant degradation or loss of functionality;
gamma stability, i.e. the reinforcing material resists at least 10 kGy, more preferably 25 kGy, most preferably 50 kGy, without significant degradation or loss of functionality;
a tensile strength: >5.2 MPa, preferred >6.8 MPa (Tensile tests are performed using a 2.5 kN testing machine (ZWICK & ROLL). The temperature during measurements is 20° C./room temperature. Tensile specimen are 150 mm long, 20 mm wide. Each specimen is placed centrally in the testing machine's specimen mounts. Pulling speed for all measurements is 50 mm/min. The value tensile strength is defined as the highest tensile strength at sample break (Rm).);
compressibility: ≥85%, preferably >90% of the initial thickness remains. In order to measure the compressibility, the following method is used. Hereby the thickness is measured while a defined pressure is on the material, and over time the reduction of thickness is measured. Thickness measurements were carried out with an Universal Micrometer (FRANK PTI GmbH). A round push rod with an area of 10 cm² is used as specimen mount. Round samples of 47 mm diameter are placed between the plate and the push rod. For a compressibility measurement thickness is measured by the compression of a weight of 1 kg that is placed on top of the push rod while monitoring the sample's thickness for 5 min. Compression is calculated by:

$$Compression [ \% ] = \frac{thickness after compression with 1 Kg}{thickness before compression with 1 Kg} \cdot 100$$

a homogeneity in thickness and density of at most 10% variation around the mean value.

Due to the presence of an additional reinforcing material, the processability (rinsing, impregnation, drying of roll material) in the x/y direction of the separation matrix can be advantageously increased since the force absorption without significant length change (elongation) in the pull direction for possible production/modification processes (weaving processes) can be increased when compared to an embodiment without reinforcing material. In addition, the choice of material of the reinforcing material (e.g. a thermoplastic resin) can ensure an improved attachment of the separation matrix to thermoplastic device parts of a chromatography unit. Accordingly, the manufacturability of an integrated chromatography device can be improved by an additional reinforcing material.

According to a preferred embodiment of the present invention, the median bridge diameter of the first continuous phase is from 0.4 to 4 times larger than the median pore diameter of the non-cylindrical large diameter continuously connected convective pores. This ratio is strongly dependent on the convective porosity ε (e.g. in case ε=0.33 (i.e. at a convective porosity of 33%) so that 4.4·e^{-0.03·(ε·100)} is equivalent to a bridge to pore ratio of 1.63), as described by the following equation.

$$bridge to pore ratio = \frac{median bridge diameter [ μm ]}{median pore diameter [ μm ]} = 4.4 \cdot {e}^{- 0.03 \cdot ( ε \cdot 100 )}$$

As used herein, the median bridge diameter is defined as the median value of all pore data from the method in scientific publication Ley et. al, Journal of Membrane Science, Volume 564, 2018, Pages 543-551, when the phases for the binary structure where inverted (1 goes 0 and vice versa) (cf. Pages 546-548 thereof). Preferably, the median bridge diameter of the first continuous phase is from 1 to 3 times larger than the median pore diameter of the non-cylindrical large diameter continuously connected convective pores, more preferably from 1 to 2 times larger. A ratio outside of the above range may negatively affect the surface accessibility, and thus also the binding or process time.

According to a preferred embodiment of the present invention, when a convective porosity ε is the ratio of the volume of the second continuous phase to the total volume of the first and second continuous phase, the convective porosity ε is from 0.05 to 0.7, more preferred from 0.05 to 0.5, and most preferred from 0.1 to 0.4. The convective porosity ε can be determined by inverse size exclusion chromatography as known by a person skilled in the art and shown exemplary in a modified form in Guan, Hong & Guiochon, Georges (1996) “Study of physico-chemical properties of some packing materials” (Journal of Chromatography A—J CHROMATOGR A. 731. 27-40. 10.1016/0021-9673(95)01197-8). As used herein, the “total volume of the first and second continuous phase” refers to the sum of the volume of the first phase and the volume of the second phase, without taking an optional inert third phase (and its volume) in the chromatographic material of the present invention into account. If the convective porosity is smaller than the above-defined range, the permeability of the chromatographic material may decrease due to the presence of a larger amount of polysaccharide material in the chromatographic material. If the convective porosity is larger than the above-defined range, the binding capacity of the chromatographic material may decrease due to the presence of a smaller amount of polysaccharide material in the chromatographic material.

According to a preferred embodiment of the present invention, the chromatographic material of the present invention has a permeability of at least 0.31×(ε×100) mD (milliDarcy), more preferred at least 1.52×(ε×100) mD and most preferred at least 3.1×(ε×100) mD, wherein ε is the convective porosity as defined above. Accordingly, when the convective porosity ε is 0.33 (i.e. a convective porosity of 33%), the chromatographic material of the present invention preferably has a permeability of at least 10.2 mD, more preferably at least 50.2 mD, and most preferably at least 102 mD. The permeability strongly depends on the convective porosity ε. This is accessible through geometrical considerations. At constant median pore diameter and a higher convective porosity, a higher number of pores has to be present and therefore a higher volume flow at constant pressure. For smaller convective porosities vice versa. The permeability may e.g. be determined as described in scientific publication Ley et. al, Journal of Membrane Science, Volume 564, 2018, Pages 543-551 (page 547: description; page 545: measurement). The higher the permeability is, the smaller the required process pressure in chromatographic processes using the chromatographic material is. This advantageously allows greater column lengths and greater bed heights in chromatographic processes and therefore lower axial dispersion. Moreover, determination of the permeability is also a method to confirm a bi-continuous structure of the separation matrix since a permeability of lower than 0.31×(ε×100) mD (e.g. 10.2 mD at a convective porosity of 33% (i.e. ε=0.33)) is a strong indication of the absence of a continuous convective phase.

According to a preferred embodiment of the present invention, the coefficient of variance of the median pore diameter of the non-cylindrical large diameter continuously connected convective pores is at most 0.8, more preferred at most 0.7. As used herein, the coefficient of variance of the median pore diameter is the standard deviation of the median pore diameter divided by the mean value of the median pore diameter. The “standard deviation” of the median pore diameter may be determined by using the Microsoft Excel function “STABW.N” which calculates the standard deviation based on a population specified as arguments (logical values and text are ignored). The standard deviation is a measure of the dispersion of values with respect to their mean (the mean). If the coefficient of variance of the median pore diameter of the non-cylindrical large convective pores is higher than the above maximum, the performance of the chromatographic material in a chromatographic process may decrease, i.e. earlier breakthrough curves, broader elution peaks and smaller chromatographic resolution may occur.

According to a preferred embodiment of the present invention, the coefficient of variance of the median bridge diameter of the first continuous phase is at most 0.7, more preferred at most 0.6. As used herein, the coefficient of variance of the median bridge diameter is the standard deviation of the median bridge diameter divided by the mean value of the median bridge diameter. The standard deviation of the median bridge diameter is determined analogously to the method described above for the standard deviation of the median pore diameter. If the coefficient of variance of the median bridge diameter of the first continuous phase is higher than the above maximum, it may occur that the binding sites of the separation matrix cannot be fully utilized, leading to earlier breakthrough and broader elution peaks in chromatographic processes.

According to a further preferred embodiment of the present invention, the separation matrix of the chromatographic material of the present invention has a specific interface between the first and the second continuous phases of at least 0.04 m²/mL (wherein the volume mL refers to the separation matrix volume without the optional third inert phase/reinforcing material), more preferred more than 0.1 ²/mL and most preferred more than 0.2 m²/mL. The specific interface between the first and the second continuous phases can be determined by the following equation if the tortuosity is 2.5. If the tortuosity is different from this exemplary but typical tortuosity than the permeability changes by a factor that the then observed tortuosity differs from 2.5 to higher permeabilities (for lower tortuosities) or lower permeabilities (for higher tortuosities) like it is known to a person skilled in the art and given in the following equation (cf. also the scientific publication Berg et. al, Transport in Porous Media, 2014, Page 10, https://arxiv.org/pdf/1505.02424.pdf).

$${Interface}_{specific} = ( - 37.868 {ϵ}^{5} + 75.428 {ϵ}^{4} - 66.017 {ϵ}^{3} + 34.08 {ϵ}^{2} - 2.7346 ϵ + 0.1333 ) \cdot {Permeability}^{- 0.5}$$

$${Permeability}_{with tortuosity different than 2.5} = \frac{{Permeability}_{with a tortuosity of 2.5}}{\frac{tortuosity}{2.5}}$$

If the specific interface between the first and the second continuous phases is below 0.04 m²/mL, the interface for the transition into the small diameter diffusion pores may be too small such that less components (target substances and/or contaminants) may diffuse into the first continuous phase. Accordingly, the mass transport and thus the binding capacity may be limited while the diffusion time remains the same, leading to either smaller binding capacity or longer process times.

The shape of the chromatographic material, independent of the presence of the optional third inert phase, is not particularly limited. Accordingly, the chromatographic material may be e.g. in the shape of a flat sheet (membrane) or hollow fibre membrane, monolith or particles.

A further aspect of the present invention relates to a method of producing the chromatographic material of the present invention. Each of the embodiments described above also applies for the chromatographic material produced by the method of the present invention.

In particular, there is provided a method of producing the chromatographic material comprising a polymer network material-based self-supporting bi-continuous separation matrix of the present invention, wherein the first continuous phase is formed by a self-gelled polysaccharide, the method comprising the steps of:
(a) preparing a solution (A) comprising a self-gelling polysaccharide and a first solvent;
(b) preparing a solution (B) comprising at least one surfactant and a second solvent which is an immiscible solvent to solution (A);
(c) combining solution (A) and solution (B) to produce a combined solution (C);
(d) emulsifying the combined solution (C) at a condition to allow the self-gelling polysaccharide to remain in solution in the first solvent as solution (A) to obtain an emulsion which is in form of a solution (B)-in-solution (A)-emulsion; and
(e) allowing solution (A) containing the self-gelling polysaccharide to solidify by gelation at a certain condition to form the chromatographic material which comprises the separation matrix comprising the self-gelled polysaccharide as the first continuous phase.

In step (a) of the method of the present invention, a solution (A) comprising a self-gelling polysaccharide and a first solvent is prepared. The first solvent is not particularly limited and every solvent in which the self-gelling polysaccharide is soluble (at room temperature or at elevated temperature) can be used. The first solvent may also be a mixture of two or more of such solvents. According to a preferred embodiment, the first solvent is water. Solution (A) may be prepared by stirring and heating the self-gelling polysaccharide and the first solvent (to e.g. 30° C. or more, 40° C. or more, 50° C. or more, 60° C. or more, 70° C. or more, 80° C. or more, or 90° C. or more) for a predetermined time (e.g. 2 min or more, 5 min or more, 10 min or more, 15 min or more) until the self-gelling polysaccharide is (completely) dissolved in the first solvent.

The concentration of the self-gelling polysaccharide is not particularly limited. According to a preferred embodiment, the concentration of the polysaccharide in solution (A) is from 0.5 to 8 wt %, preferably from 1 to 6 wt %, and most preferably from 2.5 to 5 wt %. If the concentration is below the above range, the gelling ability of the self-gelling polysaccharide may not be sufficient, which may lead to deterioration of the stability of the polysaccharide gel. If the concentration is above the aforementioned range, unwanted size exclusion of a target component to be bound in a chromatography process and/or exceedingly low diffusive mass transfer into the gel may occur.

In step (b) of the method of the present invention, a solution (B) comprising at least one surfactant and a second solvent which is an immiscible solvent to solution (A) is prepared. As used herein, “immiscible” means that the solubility of a solvent in another solvent is less than 100 g/L at 70° C., preferably less than 50 g/L at 70° C., and most preferably less than 10 g/L at 70° C.

The second solvent may be a single solvent or a mixture of two or more solvents. At least one solvent of the second solvent is an immiscible solvent to solution (A). According to a preferred embodiment of the present invention, the second solvent is one or more selected from C₄₋₁₂ alcohols (e.g. 1-hexanol, 2-heptanol, 1-octanol, 1-nonanol, 1-decanol, 1-dodecanol), C₄₋₁₂ isoalcohols, alkanes (e.g. octane and decane), silicone oils having a viscosity of from 4 to 200 cP, and natural oils having a viscosity of from 4 to 200 cP, or mixtures thereof. Silicone oils may e.g. be polydimethylsiloxanes (e.g. Silicone oil 20 cP from Wacker). Natural oils may e.g. be olive oil, sunflower oil or rapeseed oil. Particularly preferred embodiments of the second solvent are octane, decane, 1-octanol, 1-decanol and 1-dodecanol. The most preferred second solvent is decanol, particularly 1-decanol. Solution (B) may be e.g. prepared by stirring at room temperature or at elevated temperature, such as e.g. 30° C. or more, 35° C. or more, 40° C. or more, or 50° C. or more, for a predetermined time (e.g. 2 min or more, 5 min or more, 10 min or more, 15 min or more).

According to a preferred embodiment of the present invention, the at least one surfactant has an HLB value of from 8 to 16, preferably of from 10 to 14, and most preferably of from 11 to 13. The HLB (hydrophilic-lipophilic balance) of a surfactant is a measure of the degree to which it is hydrophilic or lipophilic, determined by calculating values for the different regions of the molecule, as described by Griffin (“Classification of Surface-Active Agents by ‘HLB’”, Journal of the Society of Cosmetic Chemists, 1949, 1 (5): 311-26); and “Calculation of HLB Values of Non-Ionic Surfactants”, Journal of the Society of Cosmetic Chemists, 1954, 5 (4): 249-56) and Davies (“A quantitative kinetic theory of emulsion type, I. Physical chemistry of the emulsifying agent”, Gas/Liquid and Liquid/Liquid Interface, Proceedings of the

International Congress of Surface Activity, 1957, pp. 426-38). Taking tabulated or calculated values for the HLB values of single surfactants, HLB values of mixtures are determined by the mass fraction like e.g. in the following formula for a mixture of 2 surfactants where m is the mass of the surfactant used and HLB is the tabulated or calculated HLB value for the specific surfactant.

$${HLB}_{mixture ( of 2 surfactants )} = \frac{{m}_{1} \cdot {HLB}_{1} + {m}_{2} \cdot {HLB}_{2}}{( {m}_{1} + {m}_{2} )}$$

The smaller the HLB-value is, the smaller the resulting convective pore diameter and resulting bridge diameter are. The HLB value is an independent parameter with respect to the volume of the polysaccharide phase (first continuous phase) and the polysaccharide concentration. If the volume ratio of the two continuous phases (first continuous phase and second continuous phase) is used to control the pore size, it also changes the convective porosity and consequently also the permeability. If the polysaccharide concentration is used to control the pore size of the second continuous phase (pore phase), the first continuous phase (polysaccharide phase/diffusive phase) is also changed. For example, when using 1-decanol as organic solvent, at higher polysaccharide concentrations, the convective pores become larger and, at the same time, the diffusive pores become smaller which may lead to exclusion of larger molecules and reduced diffusive mass transport. Conversely, again using 1-decanol as organic solvent, at lower polysaccharide concentrations, the convective pores become smaller and the diffusive pores become larger, which improves mass transport but also reduces the surface area for possible binding of target components to the separation matrix in a chromatography process. By using the above HLB-value range, it is advantageously possible to influence the convective pore size without these effects.

In view of the above, the HLB-value of the at least one surfactant is preferably within the above HLB-value range, and the at least one surfactant is further capable of generating a bi-continuous structure. Moreover, the use of at least one surfactant preferably yields an interfacial tension between both liquid phases in an emulsion of at most 1 mN/m, and is preferably non-ionic. Surface tensions between two phases were measured with a goniometer OCA 15Pro and the pendant drop method. The needle of a syringe filled with a liquid phase A, exemplary water, but all other solutions and mixtures are possible, was placed into a liquid phase B, exemplary any organic solvent that is immiscible with water, but all other solutions and mixture of liquids are possible. A droplet of phase A was dispensed in phase B, either by volume, e.g. 10 μL, or continuously with a dispense rate of e.g. 1 μL/s, and recorded with a camera placed 90° to the needle. From the curvature of the droplets and the diameter of the needle, surface tensions between phases A and B were calculated with the software SCA 22—surface/interfacial tension from Dataphysics Instruments (cf. F. K. Hansen, G. Rodsrud, Surface Tension by Pendant Drop, Journal of Colloid and Interface Science, Vol. 141, No. 1, 1991).

Preferred surfactants are polysorbates and/or C₂₋₁₅₀ fatty acid esters of sorbitol, such as e.g. commercially available Tween 20/60/80 (Tween 20: polyoxyethylene sorbitan mono-laurate; Tween 80: polyoxyethylene sorbitan mono-oleate) or Span 20/60/80/85. According to the present invention, one single surfactant or a combination of two or more surfactants may be used. According to a particularly preferred embodiment, two different surfactants are used in combination.

For manufacturing a bi-continuous structure (and not a foam structure), a minimum surfactant concentration has to be used depending on the used organic solvent and on the polysaccharide concentration. For example, based on the volumetric ratio of the total volume of the solvents (i.e. both of the first and second solvent) and the surfactant(s), the preferred amount of surfactant is calculated by the formula given below and describes only the percentage of surfactant that is at least present in solution (B), and the preferred amount is at least 2.5 vol % for 1-dodecanol, at least 4.5 vol % for 1-decanol, at least 7.5 vol % for 1-nonanol, at least 7.5 vol % for 1-octanol, at least 15 vol % for 1-hexanol, at least 7.5 vol % for 2-heptanol, at least 2 vol % for cyclohexane, at least 3 vol % for octane, at least 2.5 vol % for decane, and at least 7 vol % for silicone oil (PDMS). This surfactant concentration is hereby calculated in dependence on the total amount of organic phase used by be following equation. The higher the total amount of organic phase the higher the total amount of surfactant needed.

$$surfactant concentration [ in vol \% ] = ( \frac{{v}_{\%} surfactant}{{v}_{\%} organic solvent} ) \times 100$$

The above surfactant concentrations (depending on the organic solvent) are particularly preferably used in case the concentration of the polysaccharide in solution (A) is from 2.5 to 5 wt %.

In step (c) of the method of the present invention, solution (A) and solution (B) are combined to produce a combined solution (C). Step (c) may be carried out at room temperature or at elevated temperature, such as e.g. 30° C. or more, 35° C. or more, 40° C. or more, or 50° C. or more. According to a preferred embodiment, the volume ratio of the second solvent in the combined solution (C) in step (c) is from 10 to 70 vol % since in this range a suitable emulsion can be generated in step (d) of the present invention.

In step (d) of the method of the present invention, the combined solution (C) is emulsified at a condition to allow the self-gelling polysaccharide to remain in solution in the first solvent as solution (A) to obtain an emulsion which is in form of a solution (B)-in-solution (A)-emulsion. According to a preferred embodiment of the present invention, step (d) is carried out by exposing the combined solution (C) to a shear force by (vigorously) stirring, dispersing or homogenising, e.g. with a Turrax Specification: T25 digital ULTRA-TURRAX®, Model T25D, Firma IKA (at 10.000 to 20.000 rpm) or EUROSTAR 40 digital from IKA with a dispersing disk of type R1303 Dissolver Stirrer (at 1.000 rpm to 2.000 rpm). Vigorously stirring, dispersing or homogenising advantageously enables to generate non-cylindrical large diameter continuously connected convective pores having a median pore diameter of from 0.1 μm to 6 μm.

In step (e) of the method of the present invention, solution (A) containing the self-gelling polysaccharide is allowed to solidify by gelation at a certain condition to form the chromatographic material which comprises the separation matrix comprising the self-gelled polysaccharide as the first continuous phase. Allowing the self-gelling polysaccharide to solidify by gelation at a certain condition, is e.g. realized by cooling the solution (B)-in-solution (A)-emulsion to a temperature below the gelling temperature of the polysaccharide, e.g. cooling to at most 45° C., at most 40° C., at most 35° C., at most 30° C. or at most 25° C. In other embodiments, the solidification is realized e.g. by addition of e.g. potassium salts to the solution (B)-in-solution (A)-emulsion. According to a preferred embodiment of the present invention, step (e) is performed by pouring the emulsion on a casting form and cooling the emulsion below the gelling point. As used herein, a “casting form” is any surface onto which the emulsion can be given/poured to solidify, and preferably this surface is a metal surface that can be cooled down quickly, and most preferably this surface is heatable and coolable in a range of from 0° C. to 100° C. The cooling rate is not particularly limited, and usually a cooling rate of from 0.01° C./sec to 50° C./sec is used. According to a preferred embodiment of the present invention, the cooling rate is from 0.2° C./sec to 30° C./sec, particularly preferred from 1° C./sec to 20° C./sec.

In case the chromatographic material is intended to also comprise a third inert phase acting as a reinforcing material, the third inert phase is preferably present in step (e) of the method of the present invention to introduce the third inert phase (randomly) into the separation matrix. That is, it is preferred that the solution (B)-in-solution (A)-emulsion of step (d) is poured onto a reinforcing material (third inert phase) in step (e) and the solution (A) is allowed to solidify by gelation in the presence of the third inert phase.

According to a particularly preferred embodiment of the method of the present invention, the self-gelling polysaccharide is agarose, and the method comprises the steps of:
(a) preparing the solution (A) comprising the agarose and water by heating an agarose-in-water-suspension to at least 90° C. for at least 15 minutes to solve the agarose in the water;
(b) preparing the solution (B) comprising the at least one surfactant and the second solvent which is a water-immiscible organic solvent and heating solution (B) to a temperature above the gelation temperature of the used agarose (e.g. at least 40° C.);
(c) combining solution (A) and solution (B) at a temperature above the gelation temperature of the used agarose (e.g. at least 40° C.) to produce a combined solution (C);
(d) emulsifying combined solution (C) at a temperature above the gelation temperature of the used agarose (e.g. at least 40° C.) to allow the agarose to remain in solution in the first solvent as solution (A) to obtain an emulsion which is in form of a solution (B)-in-solution (A)-emulsion; and
(e) allowing solution (A) containing the self-gelling agarose to solidify by gelation at a temperature below the gelation temperature of the used agarose (e.g. below 35° C.) to form the chromatographic material which comprises the separation matrix comprising the self-gelled agarose as the first continuous phase.

The separation matrix may optionally be modified by introducing functional groups and/or ligands such as e.g. anionic ligands, cationic ligands, hydrophobic ligands, mixed mode ligands (for example two or more functionalities like e.g. cationic and hydrophobic), affinity ligands, etc. Such modifications by introducing functional groups and/or ligands is well-known to those skilled in the art.

According to the present invention, it is advantageously possible to provide a chromatographic material comprising a polymer network material-based self-supporting bi-continuous separation matrix having both diffusion pores and convective pores, the convective pores having a very small size when compared to separation matrices known in the prior art. Due to the small convective pores, the diffusive path length is also rather small and the diffusive pores within the porous bridges of the separation matrix are accessible within very short diffusion times. Moreover, the chromatographic material of the present invention shows, compared to purely convective matrices, a high permeability due to its specific structure, thus leading to a smaller process pressure when using the chromatographic material in chromatographic processes. This advantageously allows longer column lengths in chromatographic processes and lower axial dispersion. Moreover, the chromatographic material of the present invention advantageously shows a lower fouling propensity when compared to state-of-the-art materials. In view of the above, the chromatographic material of the present invention advantageously allows to operate chromatographic processes very quickly and efficiently by excellent accessibility of the binding sites, late breakthrough curves and narrow elution peaks, and thus the separation matrix of the present invention is particularly suited for diffusion limited processes that need high binding capacities, as e.g. observed in bind and elute applications of large proteins, virus particles and the like.

The Figures show:

FIG. 1 shows a comparison of the convective and diffusional flow paths in polysaccharide particles and polysaccharide membranes.

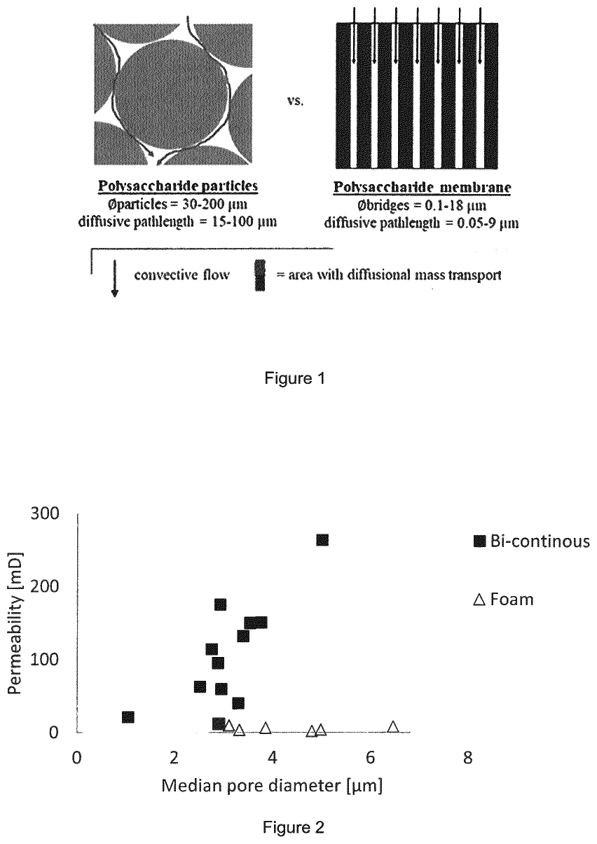

FIG. 2 shows the relationship between the permeability and the median diameter of the convective pores (at ε=0.33 convective porosity) for bi-continuous and closed-cell foam structures (Example 1).

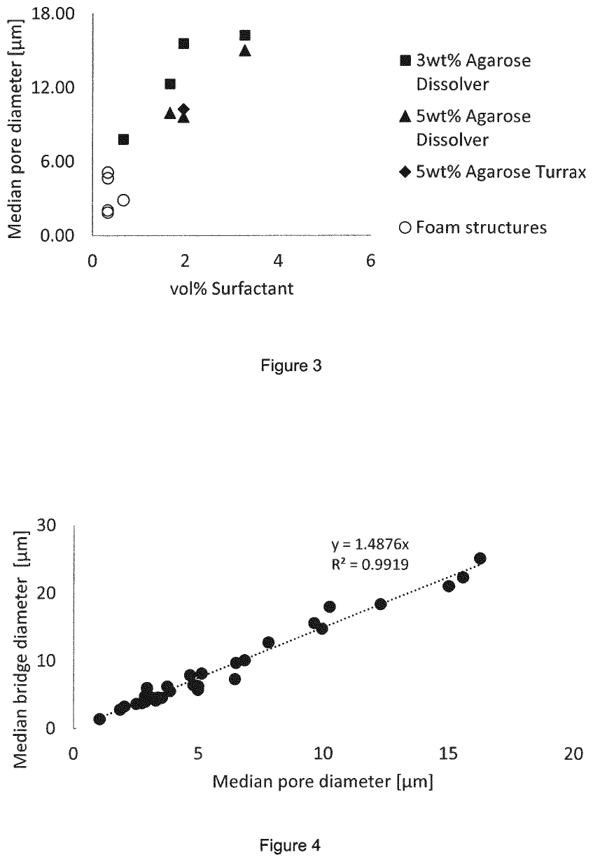

FIG. 3 shows the relationship of the median pore diameter and the used surfactant concentration (at ε=0.33 convective porosity) in the preparation of chromatographic materials in accordance with the reaction conditions (process parameters) described in U.S. Pat. No. 5,723,601 A (Example 1).

FIG. 4 shows the proportionality of the median bridge diameter and the median pore diameter (at ε=0.33 convective porosity) of the non-cylindrical large diameter continuously connected convective pores for selected examples of Table 2 (Example 2).

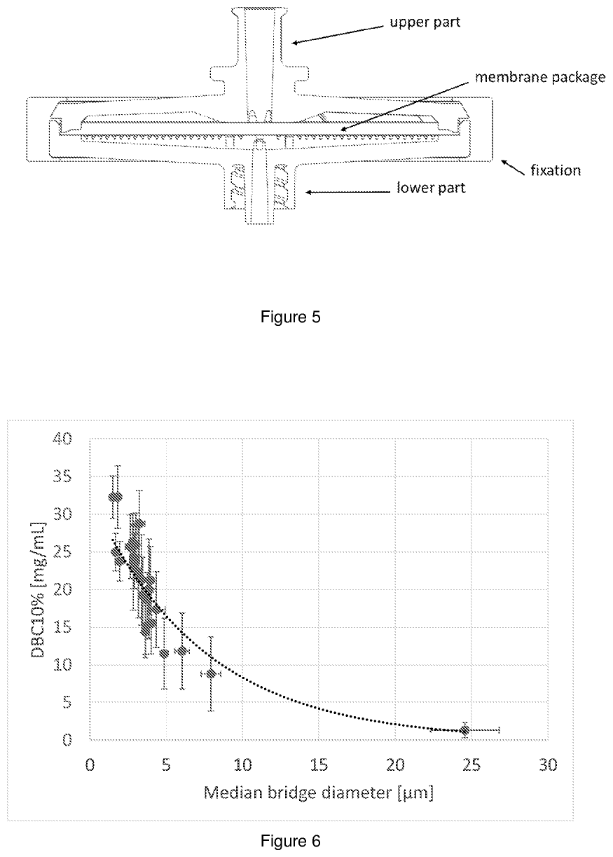

FIG. 5 shows a device for determining DBC 10%.

FIG. 6 shows a relationship between the median bridge diameter of the separation matrix and the dynamic binding capacity (at ε=0.33 convective porosity) (Example 3).

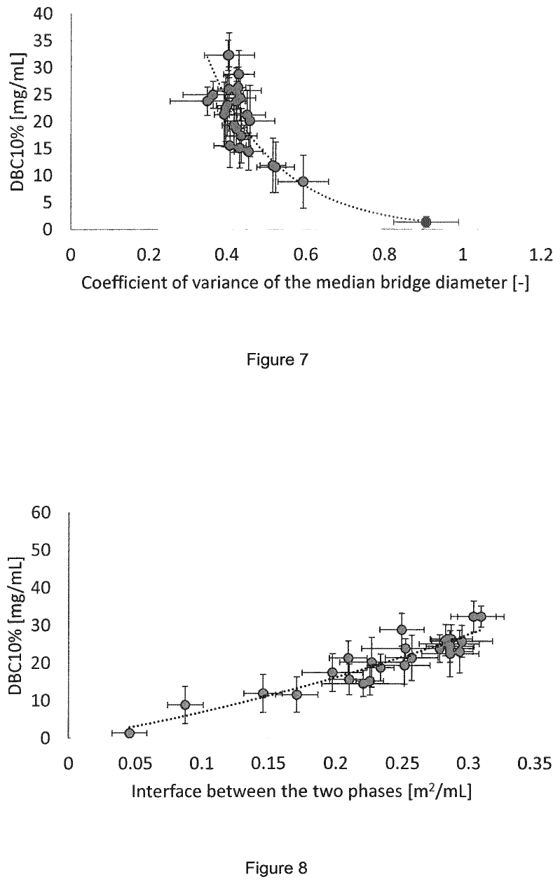

FIG. 7 shows a relationship between the coefficient of variance of the median bridge diameter of the first continuous phase and the dynamic binding capacity (at ε=0.33 convective porosity) (Example 4).

FIG. 8 shows a relationship between specific interface between the first and the second continuous phases and the dynamic binding capacity (at ε=0.33 convective porosity) (Example 5).

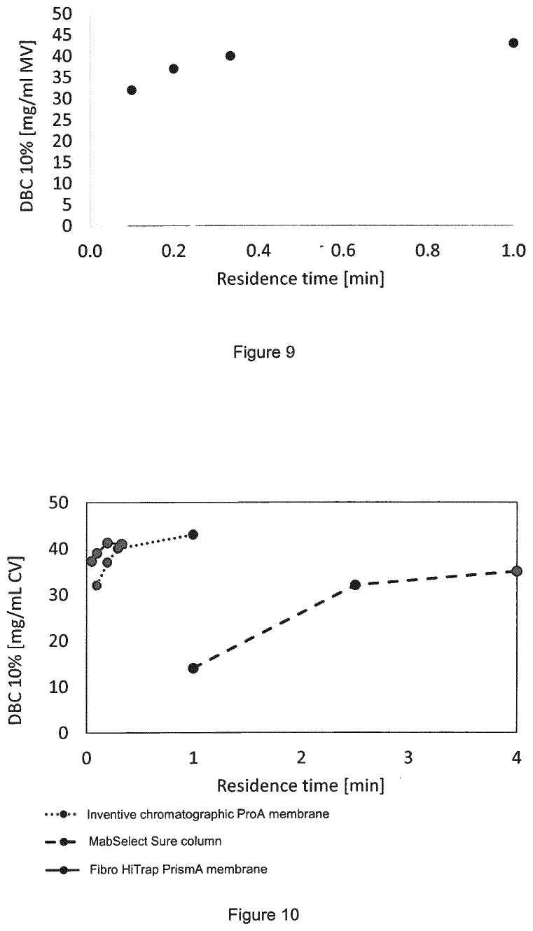

FIG. 9 shows DBC 10% in dependence of the residence time (Example 8).

FIG. 10 shows a comparison of DBC 10% of the inventive chromatographic material and state-of-the-art materials as a function of the residence time (Example 8).

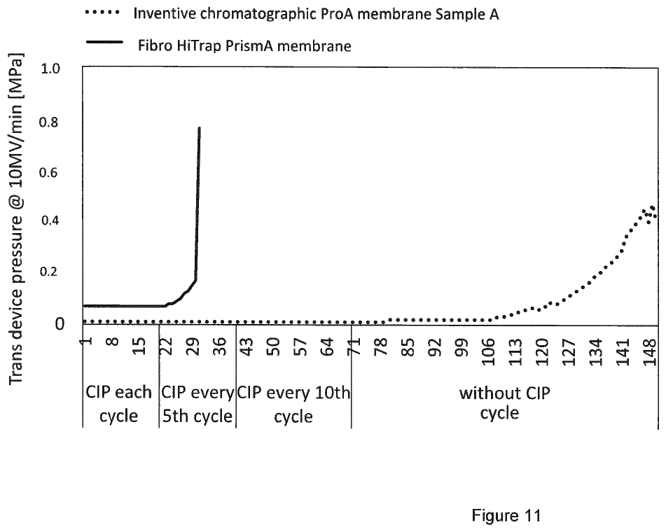

FIG. 11 shows the trans-device pressure during cycling with different cleaning strategies (load: mAb in clarified cell culture at an mAb concentration of 2.8 mg/mL) (Example 9).

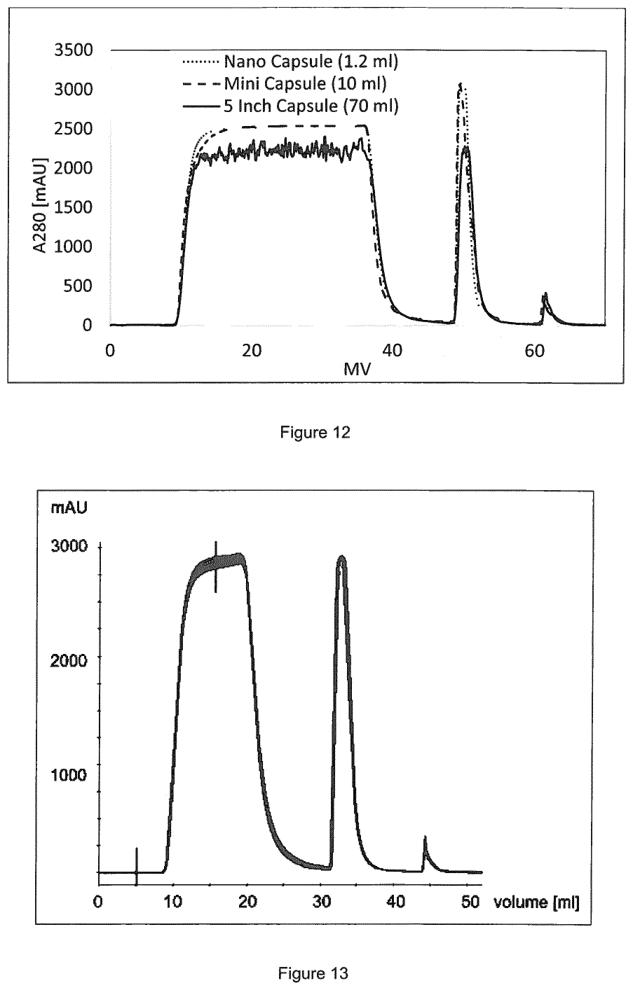

FIG. 12 shows overlayed chromatograms of a single bind & elute cycle for three different chromatography modules (Example 10).

FIG. 13 shows an overlay of 200 cycles with mAb A, UV signal at 280 nm (Example 11).

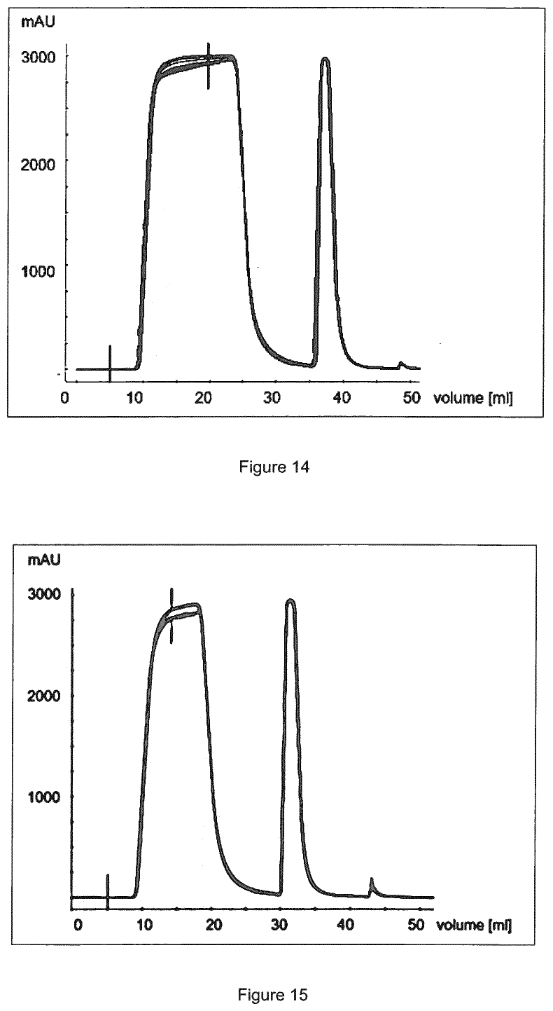

FIG. 14 shows an overlay of 200 cycles with mAb B, UV signal at 280 nm (Example 11).

FIG. 15 shows an overlay of 200 cycles with mAb C, UV signal at 280 nm (Example 11).

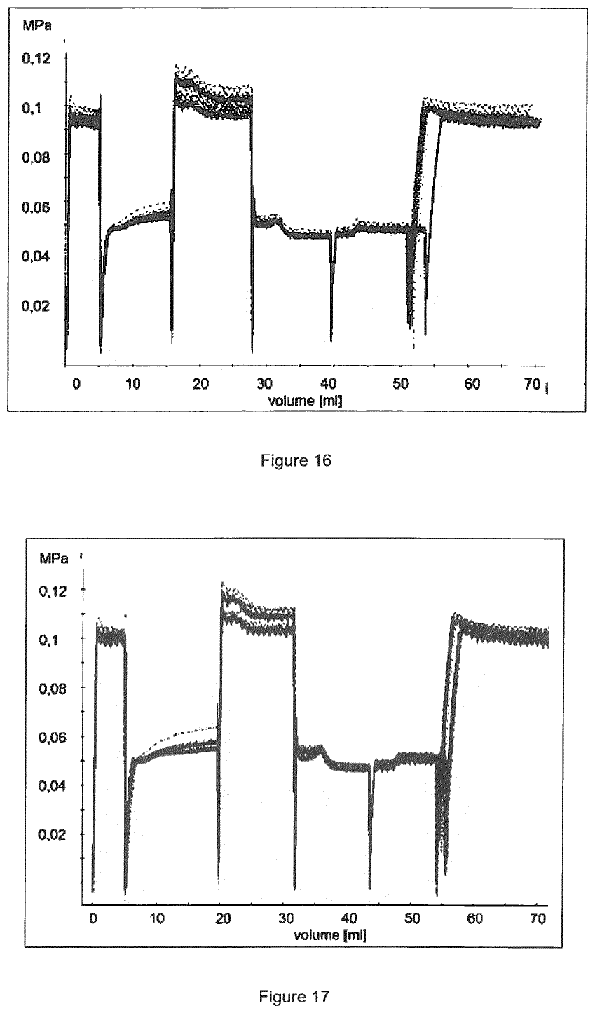

FIG. 16 shows an overlay of 200 cycles with mAb A, delta pressure [MPa] (Example 11)

FIG. 17 shows an overlay of 200 cycles with mAb B, delta pressure [MPa] (Example 11).

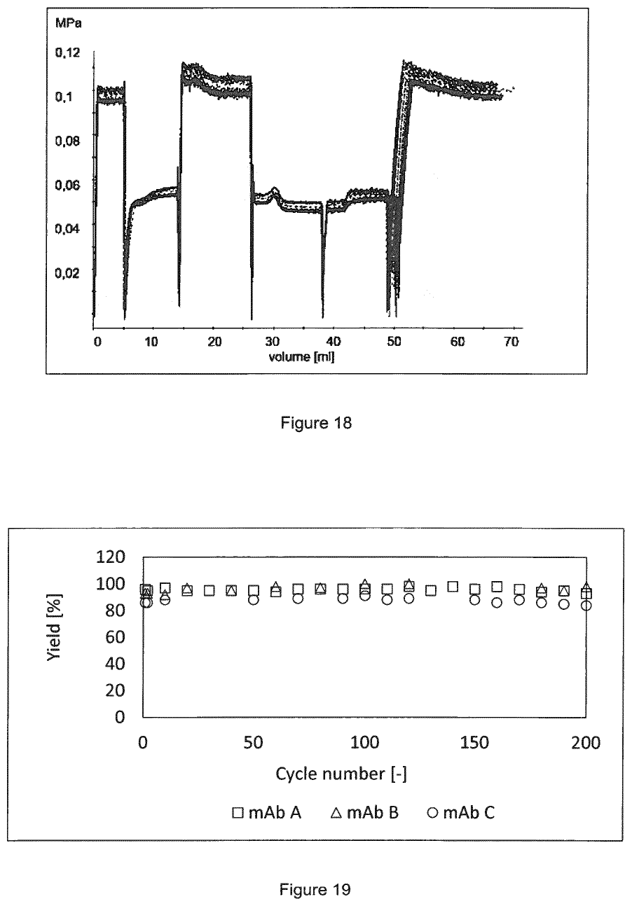

FIG. 18 shows an overlay of 200 cycles with mAb C, delta pressure [MPa] (Example 11).

FIG. 19 shows the yield vs. cycle number for mAbs A, B and C (Example 11).

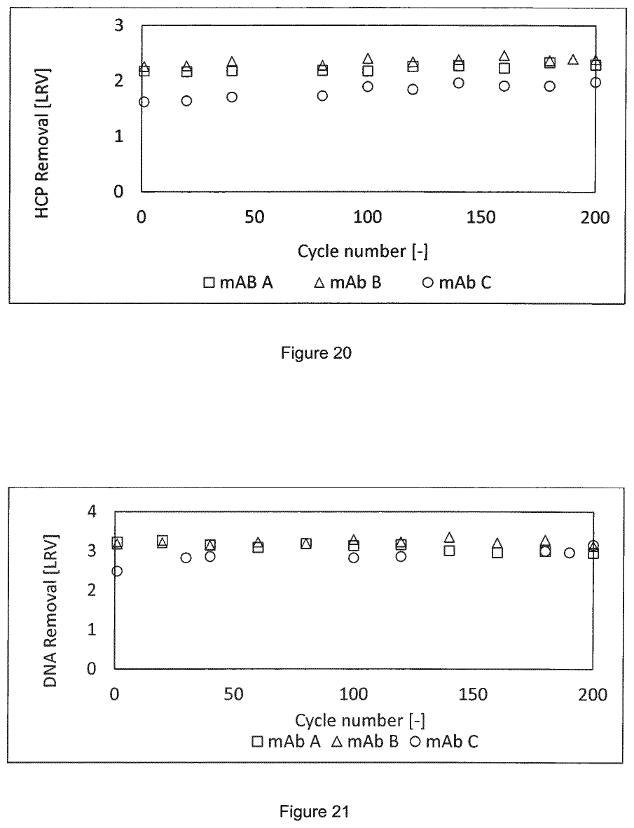

FIG. 20 shows the HCP removal vs. cycle number for mAbs A, B and C (Example 11).

FIG. 21 shows the DNA removal vs. cycle number for mAbs A, B and C (Example 11).

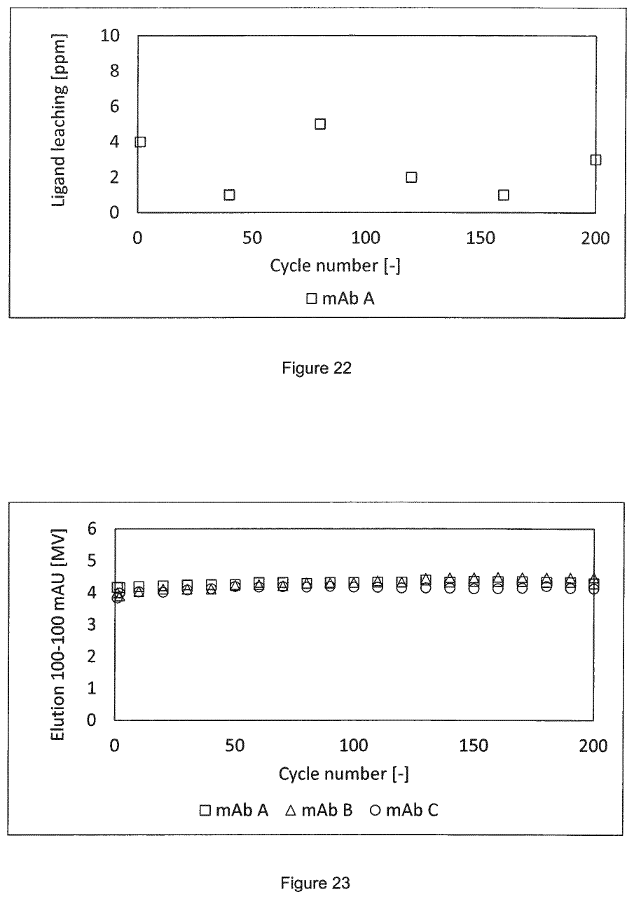

FIG. 22 shows the ProA ligand leaching vs. cycle number for mAbs A, B and C (Example 11).

FIG. 23 shows the elution peak width vs. cycle number for mAbs A, B and C (Example 11).

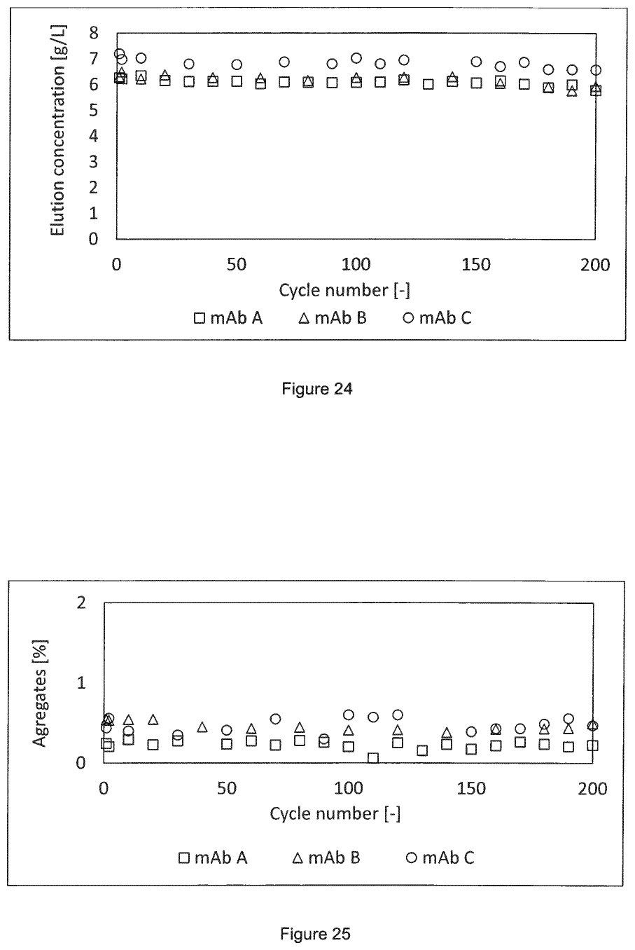

FIG. 24 shows the pool concentration vs. cycle number for mAbs A, B and C (Example 11).

FIG. 25 shows the aggregate concentration vs. cycle number for mAbs A, B and C (Example 11).

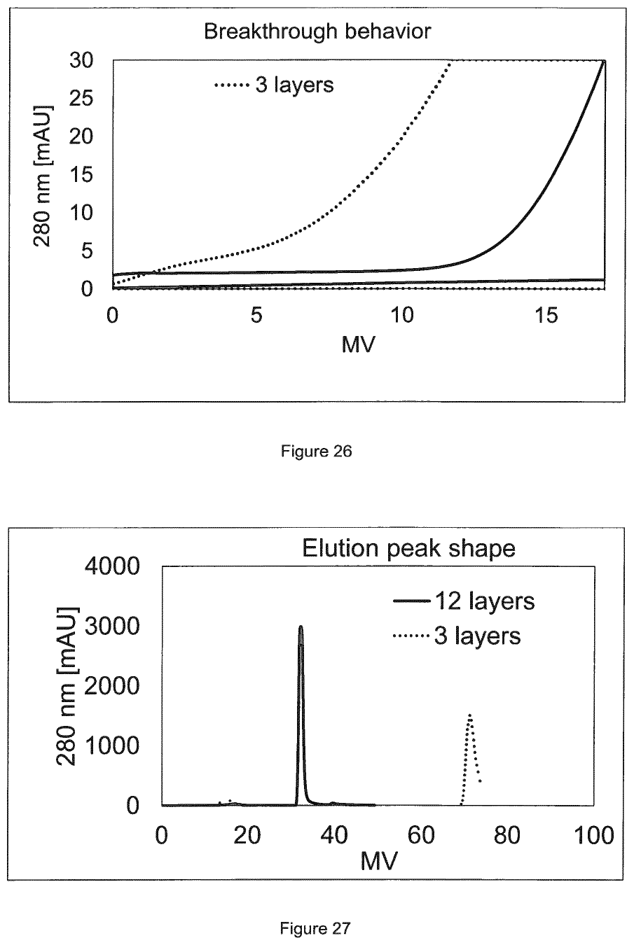

FIG. 26 shows the breakthrough behavior of an inventive 3-layer and 12-layer chromatographic device (Example 12).

FIG. 27 shows the elution peak shape of an inventive 3-layer and 12-layer chromatographic device (Example 12).

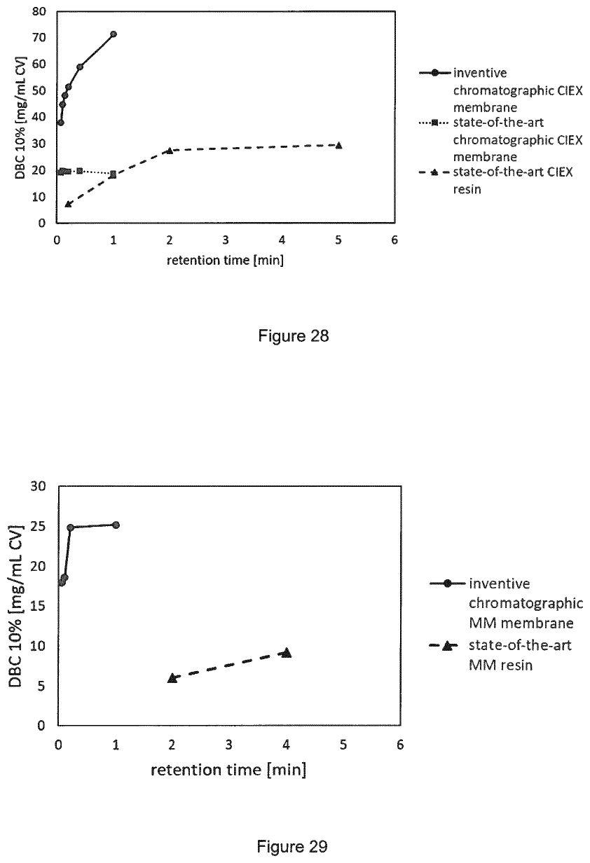

FIG. 28 shows DBC 10% results as a function of the residence time for CIEX materials (Example 13).

FIG. 29 shows DBC 10% results as a function of the residence time for MM materials (Example 13).

The present invention will be further illustrated in the following examples without being limited thereto.

### EXAMPLES

### General Preparation Example:

A self-gelling polysaccharide solution (e.g. 3% agarose in water) was prepared and stored at elevated temperature (e.g. 95° C.) until dissolved completely. Decanol (e.g. 27.39 g), Tween80 (e.g. 2.48 g) and Span80 (e.g. 0.98 g) were mixed and stirred at elevated temperature (e.g. 60° C.) to form an organic phase. The above self-gelling polysaccharide solution (e.g. agarose solution in an amount of 63.72 g) was poured into a beaker tempered in a water tub at 50° C., and the organic phase was added slowly while stirring. The emulsion was rigorously stirred with an Ultraturrax (preferably) at 20.000 rpm and 70-75° C. for 10 min. Alternatively, the emulsion was rigorously stirred with an EUROSTAR 40 digital from IKA with a dispersing disk of type R1303 Dissolver Stirrer (preferably at 2.000 rpm). The temperature was observed during the emulsion process and the water tub cooled or warmed if needed to keep the emulsion temperature constant. In the meantime, the casting platform was prepared. For this, optional a sheet of fleece (third inert phase) acting as a reinforcing material was taped at both ends of the casting platform which was tempered at 40° C. by a stream of warm water from below. The same process also works without third inert phase (reinforcing material/fleece). The emulsion was poured onto the one end of the casting platform (in presence of fleece on the top of the fleece) and was spread with a scraper to obtain a layer of emulsion with a width of e.g. 300 μm. The casting platform was immediately cooled down to 15° C. using cold tap water from below. By this, gelation of the agarose was induced. After waiting for 1 to 2 minutes, the emulsion became a firm film (optional attached to the fleece). The membrane with or without reinforcing material/fleece was removed carefully from the casting platform and placed into a tub with running water to wash out the organic phase. After washing the membrane with running water for 20 min, it was gently shaken in isopropanol (2×10 min) and water/isopropanol mixture (50:50, 2×10 min), each step including a change of washing medium. Finally, the membrane was washed in running water for another min.

For confocal microscopy analysis samples without reinforcing material/fleece proved to be the easiest way to obtain good microscope images. For this, a small hole with a diameter of 13 mm was cut into the fleece before casting the emulsion. The casting procedure was the same as stated above. Before the washing procedure, the membrane was cut out at that same hole and a membrane without fleece was obtained.

Ligand immobilization for an affinity ligand (Protein A) was carried out in a two-step process. In a first step, the activation is carried out with a bisoxirane molecule in case the matrix has functional groups that reacts with oxirane so that at least one oxirane group of the bisoxirane reacts with the matrix. The so created unreacted oxiranes on the matrix surface are then available for further surface chemistry.

The second step is carried out by adding the ligand to the activated matrix which has at least one reactive side with respect to the oxirane. This or similar possible methods can be found in A. Krishna Mallia, Paul K. Smith, Greg T. Hermanson, Immobilized Affinity Ligand Techniques, Elsevier Science, 1992.

### Example 1

### Preparation and Characterization of Chromatographic Materials According to the Present Invention and of the Prior Art

According to the above general preparation example, chromatographic material Sample Nos. 1 to 33 were prepared under the conditions indicated in Table 1. The affinity ligand was introduced by dissolving the used protein A Ligand in 1M KPI buffer with 10 mg/mL in concentration at pH 7. After preparing this coupling solution the separation matrix was inserted in this coupling solution at room temperature for at least 16 h. After this, the separation matrix was washed with 0.1M 1×PBS buffer at pH 7 and stored in this until usage.

In this Example and in the following Examples, the chromatographic materials were characterized with respect to
Ligand density:
Protein A Material: BCA assay, Literature: C. M. Stoscheck: Quantitation of protein. In: Methods in enzymology. Band 182, 1990, S. 50-68, PMID 2314256 IEX Material: Titration with e.g. NaOH or HCl as known to persons skilled in the art.
Determination of SBC (static binding capacity):
The SBC value is measured by a 12 h incubation of the target molecule in binding buffer conditions and an elution step after washing in elution condition buffer for the target molecule for at least 1 h. The concentration in the elution buffer is measured by UV-Vis at 280 nm within a calibration curve measured prior to the SBC measurement.
Determination of DBC 10% (Dynamic binding capacity at 10% breakthrough):
The DBC 10% is measured with an Äkta Avant150 chromatography System from GE-Healthcare®. At first the described material is placed into an in-house measurement device (LP15, FIG. 5) and connected to the Äkta Avant150 via luer-lock. Then at least 20 separation-matrix volumes (MV) of binding buffer were purged through the separation matrix. Then binding buffer with solved target protein (1 mg/mL) is purged through the separation matrix until 10% of the concentration of the initial target protein solution is reached (0.1 mg/mL). This until then purged volume in mL is due to the concentration of 1 mg/mL equivalent with the mass in mg and gives the DBC 10% by dividing by the separation matrix volume to derive the DBC 10% in mg/mL.
Determination of DBC 100% (Dynamic binding capacity at 100% breakthrough):
The DBC 100% is measured with an Äkta Avant150 chromatography System from GE-Healthcare®. At first the described material is placed into an in-house measurement device (LP15, FIG. 5) and connected to the Äkta Avant150 via luer-lock. Then at least 20 separation-matrix volumes (MV) of binding buffer were purged through the separation matrix. Then binding buffer with solved target protein (1 mg/mL) is purged through the separation matrix until 100% of the concentration of the initial target protein solution is reached (1 mg/mL). The area under the so derived breakthrough curve can then be integrated and the DBC 100% can then be determined by the measured area, the needed volume to reach 100% of the initial concentration and the separation matrix volume in mg/mL.

Results of the characterization of the separation matrices are indicated in Table 2.

TABLE 1

| | | | Stirrer | | Agarose | Aqueous | Organic | Surfactants | Tween | Span | |
|---|---|---|---|---|---|---|---|---|---|---|---|
| Sample | Structure | Emulsified | Speed | Organic | concentration | phase | phase | total | 80 | 80 | HLB |
| No. | Type | by | [1/min] | phase | [wt. %] | [v %] | [v %] | [v %] | [v %] | [v %] | [—] |
| 1 | Bicontinuous | (A) | 2000 | Cyclohexane | 3 | 65.34 | 32.70 | 1.96 | 1.96 | 0.00 | 15.00 |
| 2 | Bicontinuous | (A) | 2000 | Cyclohexane | 3 | 64.02 | 32.70 | 3.28 | 3.28 | 0.00 | 15.00 |
| 3 | Bicontinuous | (A) | 2000 | Cyclohexane | 3 | 65.63 | 32.70 | 1.67 | 1.67 | 0.00 | 15.00 |
| 4 | Bicontinuous | (A) | 2000 | Cyclohexane | 3 | 66.63 | 32.70 | 0.67 | 0.67 | 0.00 | 15.00 |
| 5 | Bicontinuous | (B) | 10000 | Cyclohexane | 3 | 65.34 | 32.70 | 1.96 | 1.96 | 0.00 | 15.00 |
| 6 | Bicontinuous | (A) | 2000 | Cyclohexane | 5 | 65.34 | 32.70 | 1.96 | 1.96 | 0.00 | 15.00 |
| 7 | Bicontinuous | (A) | 2000 | Cyclohexane | 5 | 64.02 | 32.70 | 3.28 | 3.28 | 0.00 | 15.00 |
| 8 | Bicontinuous | (A) | 2000 | Cyclohexane | 5 | 65.63 | 32.70 | 1.67 | 1.67 | 0.00 | 15.00 |
| 9 | Bicontinuous | (A) | 2000 | Cyclohexane | 6 | 65.34 | 32.70 | 1.96 | 1.96 | 0.00 | 15.00 |
| 10 | Bicontinuous | (A) | 2000 | Cyclohexane | 8 | 65.34 | 32.70 | 1.96 | 1.96 | 0.00 | 15.00 |
| 11 | Foam | (A) | 2000 | Cyclohexane | 3 | 66.97 | 32.70 | 0.33 | 0.33 | 0.00 | 15.00 |
| 12 | Foam | (A) | 2000 | Cyclohexane | 6 | 66.97 | 32.70 | 0.33 | 0.33 | 0.00 | 15.00 |
| 13 | Foam | (A) | 2000 | Cyclohexane | 5 | 66.63 | 32.70 | 0.67 | 0.67 | 0.00 | 15.00 |
| 14 | Foam | (A) | 2000 | Cyclohexane | 5 | 66.97 | 32.70 | 0.33 | 0.33 | 0.00 | 15.00 |
| 15 | Foam | (A) | 2000 | Cyclohexane | 8 | 66.97 | 32.70 | 0.33 | 0.33 | 0.00 | 15.00 |
| 16 | Bicontinuous | (A) | 2000 | 1-Decanol | 3 | 63.72 | 33.00 | 3.28 | 2.30 | 0.98 | 11.97 |
| 17 | Bicontinuous | (A) | 2000 | 1-Decanol | 3 | 61.98 | 33.00 | 5.02 | 3.52 | 1.50 | 11.97 |
| 18 | Bicontinuous | (A) | 2000 | 1-Decanol | 4 | 63.72 | 33.00 | 3.28 | 2.30 | 0.98 | 11.97 |
| 19 | Bicontinuous | (A) | 2000 | 1-Decanol | 4 | 61.98 | 33.00 | 5.02 | 3.52 | 1.50 | 11.97 |
| 20 | Bicontinuous | (A) | 2000 | 1-Decanol | 4 | 65.33 | 33.00 | 1.67 | 1.17 | 0.50 | 11.97 |
| 21 | Bicontinuous | (B) | 20000 | 1-Octanol | 3 | 63.72 | 33.00 | 3.28 | 2.30 | 0.98 | 11.97 |
| 22 | Bicontinuous | (B) | 20000 | Decane | 3 | 68.20 | 30.00 | 1.81 | 1.30 | 0.54 | 12.03 |
| 23 | Bicontinuous | (B) | 20000 | Octane | 3 | 67.90 | 30.00 | 2.11 | 1.48 | 0.63 | 11.97 |
| 24 | Bicontinuous | (B) | 20000 | 1-Hexanol | 3 | 60.30 | 33.00 | 6.69 | 4.70 | 2.00 | 11.98 |
| 25 | Bicontinuous | (B) | 20000 | 2-Heptanol | 3 | 62.00 | 33.00 | 5.02 | 3.50 | 1.50 | 11.96 |
| 26 | Bicontinuous | (B) | 20000 | Silicone oil | 3 | 63.70 | 33.00 | 3.28 | 2.30 | 0.98 | 11.97 |
| | | | | (PDMS) | | | | | | | |
| | | | | 20cP Wacker | | | | | | | |
| 27 | Bicontinuous | (B) | 20000 | 1-Decanol | 4 | 65.33 | 33.00 | 1.67 | 1.17 | 0.50 | 11.97 |
| 28 | Foam | (A) | 2000 | 1-Decanol | 4 | 66.33 | 33.00 | 0.67 | 0.47 | 0.20 | 11.97 |
| 29 | Foam | (A) | 2000 | 1-Decanol | 4 | 66.67 | 33.00 | 0.33 | 0.23 | 0.10 | 11.97 |
| 30 | Foam | (B) | 20000 | 1-Decanol | 4 | 66.33 | 33.00 | 0.67 | 0.47 | 0.20 | 11.97 |
| 31 | Foam | (B) | 20000 | 1-Decanol | 4 | 66.67 | 33.00 | 0.33 | 0.23 | 0.10 | 11.97 |
| 32 | Foam | (A) | 2000 | 1-Decanol | 3 | 66.33 | 33.00 | 0.67 | 0.47 | 0.20 | 11.97 |
| 33 | Foam | (A) | 2000 | 1-Decanol | 3 | 66.67 | 33.00 | 0.33 | 0.23 | 0.10 | 11.97 |

(A) R1303 Dissolver Stirrer; (B) T25 digital ULTRA-TURRAX ®. Model T25D. Firma IKA

TABLE 2

| | | Median | | | Coefficient | Specific Interface | | |
|---|---|---|---|---|---|---|---|---|
| | | Pore | Coefficient of | | of Variance | between First and | | DBC 10% |
| | | Diameter | Variance of Median | Median | of Median | Second | | Protein A- |
| | | (Convective | Pore Diameter | Bridge | Bridge | continuous | | Membrane. IgG |
| Sample | Permeability | Pores) | (Convective Pores) | Diameter | Diameter | phases | Tortuosity | binding 5MV/min |
| No. | [mD] | [μm] | [—] | [μm] | [—] | [m²/mL] | [—] | [mg/ml] |
| 1 | 1123.8 | 15.57 | 0.62 | 22.31 | 0.55 | 0.03 | 2.18 | |
| 2 | 1293.4 | 16.23 | 0.64 | 25.11 | 0.54 | 0.03 | 3.05 | |
| 3 | 826.0 | 12.30 | 0.56 | 18.31 | 0.50 | 0.04 | 2.01 | |
| 4 | 393.0 | 7.80 | 0.60 | 12.68 | 0.53 | 0.06 | 1.65 | |
| 5 | 563.8 | 10.26 | 0.51 | 17.93 | 0.49 | 0.01 | 1.67 | |
| 6 | 413.9 | 9.64 | 0.55 | 15.56 | 0.52 | 0.02 | 1.42 | |
| 7 | 912.8 | 15.01 | 0.63 | 21.02 | 0.58 | 0.03 | 1.49 | |
| 8 | 259.0 | 9.95 | 0.67 | 14.71 | 0.57 | 0.05 | 1.53 | |
| 9 | 112.2 | 6.85 | 0.49 | 10.07 | 0.44 | 0.02 | 1.79 | |
| 10 | 69.7 | 6.50 | 0.57 | 9.68 | 0.47 | 0.07 | 1.73 | |
| 11 | 10.0 | 5.13 | 0.58 | 8.12 | 0.50 | 0.10 | 1.57 | |
| 12 | 1.0 | 2.05 | 0.50 | 3.28 | 0.44 | 0.26 | 2.79 | |
| 13 | 6.2 | 2.88 | 0.46 | 4.78 | 0.45 | 0.20 | 2.86 | |
| 14 | 9.3 | 4.67 | 0.58 | 7.87 | 0.53 | 0.06 | 1.35 | |
| 15 | 1.0 | 1.88 | 0.52 | 2.80 | 0.39 | 0.29 | 3.28 | |
| 16 | 95.4 | 2.88 | 0.46 | 3.96 | 0.37 | 0.23 | 3.43 | |
| 17 | 150.0 | 3.54 | 0.43 | 4.53 | 0.43 | 0.20 | 1.60 | |
| 18 | 132.3 | 3.39 | 0.55 | 4.59 | 0.40 | 0.20 | 2.76 | 32.16 |
| 19 | 263.7 | 4.99 | 0.42 | 6.26 | 0.40 | 0.15 | 1.60 | 29.68 |
| 20 | 12.0 | 2.90 | 0.45 | 4.25 | 0.41 | 0.22 | 2.62 | 39.49 |
| 21 | 62.7 | 2.52 | 0.41 | 3.64 | 0.43 | 0.26 | 2.20 | 33.6 |
| 22 | 59.6 | 2.95 | 0.73 | 5.99 | 0.56 | 0.14 | 1.49 | 36.3 |
| 23 | 150.7 | 3.76 | 0.45 | 6.18 | 0.45 | 0.16 | 4.37 | 26.85 |
| 24 | 21.3 | 1.05 | 0.35 | 1.39 | 0.35 | 0.37 | 1.89 | 29.61 |
| 25 | 114.0 | 2.76 | 0.43 | 3.76 | 0.45 | 0.25 | 1.95 | 31.06 |
| 26 | 175.2 | 2.93 | 0.44 | 4.40 | 0.44 | 0.22 | 1.71 | 29.3 |
| 27 | 40.0 | 3.30 | 0.52 | 4.13 | 0.39 | 0.21 | 3.29 | 44.86 |
| 28 | 6.4 | 3.86 | 0.64 | 5.52 | 0.41 | 0.16 | 4.05 | |
| 29 | 3.8 | 4.98 | 0.64 | 5.70 | 0.40 | 0.14 | 27.94 | |
| 30 | 9.9 | 3.11 | 0.53 | 4.61 | 0.42 | 0.21 | 2.70 | 9.65 |
| 31 | 8.2 | 6.46 | 0.72 | 7.27 | 0.38 | 0.10 | 4.83 | 5.96 |
| 32 | 3.5 | 3.32 | 0.64 | 4.40 | 0.38 | 0.20 | 3.03 | 11.38 |
| 33 | 2.0 | 4.80 | 0.70 | 6.44 | 0.42 | 0.14 | 3.60 | 9.93 |

Sample Nos. 1 to 15 are chromatographic materials prepared in accordance with the reaction conditions (process parameters) described in U.S. Pat. No. 5,723,601 A. Sample Nos. 1 to 10 are bi-continuous separation matrices, but the non-cylindrical large diameter continuously connected convective pores of each of the separation matrices have a median pore diameter of more than 6 μm. As can be seen from Sample Nos. 1 to 5, less surfactant (at constant polysaccharide concentration) leads to smaller pore diameters of the convective pores. However, in Sample Nos. 11 to 15, in which the concentration of the surfactant falls under a certain threshold, a foam structure is obtained instead of a bi-continuous structure. The foams consist of partially more or less connected globular structures as convective phase (macropores) between the diffusive phase, i.e. the macropores are not interconnected. The inherently resulting poorer connectivity results in structures with a very low permeability at comparable pore size (i.e. the median diameter of the convective pores), since there is no through flow via these pores. FIG. 2 shows the relationship between the permeability and the median diameter of the convective pores for bi-continuous and foam structures. Therefore, foam structures can only be traversed in a very inhomogeneous and inadequate manner, which results in disadvantages in the homogeneous distribution of fluid in the chromatographic medium and, in addition to the lower permeability, disadvantages in the dynamic binding due to inhomogeneous flow and thus inhomogeneous binding site accessibility.

FIG. 3 shows the relationship of the median pore diameter and the used surfactant concentration in the preparation of chromatographic materials in accordance with the reaction conditions (process parameters) described in U.S. Pat. No. 5,723,601 A. With the reaction conditions described in U.S. Pat. No. 5,723,601 A, it is not possible to prepare a bi-continuous separation matrix with non-cylindrical large diameter continuously connected convective pores having a median pore diameter of from 0.1 μm to 6 μm.

Sample Nos. 16 to 27 are chromatographic materials according to the present invention, comprising bi-continuous separation matrices with non-cylindrical large diameter continuously connected convective pores having a median pore diameter of from 0.1 μm to 6 μm. The separation matrices show an excellent permeability, particularly when compared to the foams of Sample Nos. 11 to 15 which have similar median pore diameters of the convective pores. The chromatographic material of the present invention has excellent accessibility of the binding sites and dynamic binding capacity at 10% breakthrough.

Sample Nos. 28 to 33 are chromatographic materials prepared as Comparative Examples, in which the same solvent as in (inventive) Sample Nos. 16 to 20 and 27 was used, but the concentration of surfactant used in the preparation has been lowered below a certain threshold such that foam structures are formed. Sample Nos. 28 to 33 have convective pores having a median pore diameter similar to Sample Nos. 16 to 27, but the convective pores of foam structure Sample Nos. 28 to 33 are not continuously connected (interconnected) like the convective pores of Sample Nos. 16 to 27. Accordingly, when comparing the foam structures of Sample Nos. 28 to 33 with the bi-continuous structures of Sample Nos. 16 to 27, the foam structures show a reduced permeability at comparable convective pore diameters. Moreover, the foam structures of Samples Nos. 30 to 33 show an inferior dynamic binding capacity at 10% breakthrough when compared with the bi-continuous structures of Sample Nos. 18 to 27.

### Example 2

### Relationship Between the Mean Bridge Diameter and the Mean Pore Diameter of the Large Diameter Convective Pores

Separation matrices comprising a self-gelled porous polysaccharide as the first continuous phase were prepared and analyzed with respect to their mean bridge diameter and mean pore diameter of the large diameter convective pores. The results are depicted in FIG. 4, which clearly shows the proportionality of the mean bridge diameter and the mean pore diameter of the large diameter convective pores. In particular, the bigger the large diameter convective pores become with a constant pore volume fraction (convective porosity), the bigger the bridges become because the bridges just represent the space between the large diameter convective pores.

### Example 3

### Relationship Between DBC 10% of Separation Matrices and Their Median Bridge Diameter

Separation matrices comprising a self-gelled porous polysaccharide as the first continuous phase were prepared and analyzed with respect to their median bridge diameter and DBC 10% (dynamic binding capacity 10% breakthrough (ligand: affinity protein A; buffer: phosphate-buffered saline (PBS) pH 7.3; analyte 1 mg/mL monoclonal antibody (mAb) in PBS; velocity: 5 MV/min=12 sec residence or contact time with or in the medium)). All data were derived by using flat sheet materials inside a device like shown in FIG. 5 (called LP15) and were measured with an Äkta® Avant150.

The results are depicted in FIG. 6, which clearly shows that when keeping the process parameters constant (contact and process time). the larger the median bridge diameter of the separation matrix is. the smaller also the dynamic binding capacity is.

### Example 4

### Relationship Between DBC 10% of Separation Matrices and Their Coefficient of Variance of the Median Bridge Diameter of the First Continuous Phase

Separation matrices comprising a self-gelled porous polysaccharide as the first continuous phase were prepared and analyzed with respect to their variance of the median bridge diameter of the first continuous phase and DBC 10% (ligand: affinity protein A; buffer: phosphate-buffered saline (PBS) pH 7.3; analyte 1 mg/mL monoclonal antibody (mAb) in PBS; velocity: 5 MV/min=12 sec residence or contact time with or in the medium).

The results are depicted in FIG. 7, which clearly shows that, when keeping the process parameters constant (contact and process time), the larger the coefficient of variance of the median bridge diameter is, the smaller also the dynamic binding capacity is.

### Example 5

### Relationship Between DBC 10% of Separation Matrices and Their Specific Interface Between the First and the Second Continuous Phases

Separation matrices comprising a self-gelled porous polysaccharide as the first continuous phase were prepared and analyzed with respect to their specific interface between the first and the second continuous phases and DBC 10% (ligand: affinity protein A; buffer: phosphate-buffered saline (PBS) pH 7.3; analyte 1 mg/mL monoclonal antibody (mAb) in PBS; velocity: 5 MV/min=12 sec residence or contact time with or in the medium). The separation matrices in this Example are designed to have the maximum possible static binding capacity accessible via ligand immobilization.

The results are depicted in FIG. 8, which clearly shows that, when keeping the process parameters constant (contact and process time), the larger the specific interface between the first and the second continuous phases is, the faster the mass transport can take place and the larger also the dynamic binding capacity is.

### Example 6

Inventive chromatographic membranes (Sample Nos. 34 and 35) comprising a self-gelled porous agarose as the first continuous phase were prepared according to the above-described general preparation example under the following conditions indicated in Table 3.

In particular, a self-gelling agarose solution was prepared and stored at elevated temperature (e.g. 95° C.) until dissolved completely. 1-Decanol, Tween80 and Span80 are mixed and stirred at elevated temperature (e.g. 80° C.) to form an organic phase. The above self-gelling agarose solution was poured into a vessel tempered at elevated temperature (e.g. 80° C.) and the organic phase was added slowly while stirring. The emulsion was rigorously dispersed with a Disperser YSTRAL Inline Z66 (C) at e.g. 5000 rpm. The third inert phase (e.g. fleece) acting as a reinforcing material was attached to casting platform which was kept a temperature below the gelling temperature (e.g. 30° C.). The emulsion was cast as a thin film onto the casting platform, soaking the fleece. Due to the temperature of the casting platform being below the gelling temperature of the agarose, the agarose began immediately to form the gelled inventive chromatographic membrane. The inventive chromatographic membrane with reinforcing material was removed from the casting platform, winded on a roll and rinsed with isopropanol and finally with water.

TABLE 3
Components and recipe used for sample preparation

| | | | | Agarose | Aqueous | Organic | Surfactants | Tween | | |
|---|---|---|---|---|---|---|---|---|---|---|
| Sample | Structure | Emulsified | Organic | concentration | phase | phase | total | 80 | Span 80 | |
| No. | Type | by | phase | [wt %] | [v %] | [v %] | [v %] | [v %] | [v %] | HLB |
| 34 | Bicontinuous | YSTRAL | 1-Decanol | 2.5 | 61.70 | 35.20 | 3.20 | 2.70 | 0.50 | 13.50 |
| | | Inline Z66 | | | | | | | | |
| 35 | Bicontinuous | YSTRAL | 1-Decanol | 5.0 | 64.00 | 33.00 | 3.38 | 2.43 | 0.98 | 12.00 |
| | | Inline Z66 | | | | | | | | |

### Example 7

### Impact of the Compression of the Third Inert Phase (Reinforcing Material) on the Permeability of the Inventive Chromatographic Membrane Under Typical Operating Pressures

Different flat sheet reinforcing materials were used as third inert phase for the preparation of inventive chromatographic membranes according to Example 6, Sample Nos. 34 and 35. The used reinforcing materials were fleece materials A, B and C with different compressibility measured by compression as calculated by the above-mentioned equation. For a compression measurement, the thickness is measured before and after the compression by a weight of 1 kg that is placed on top of the push rod while monitoring the sample's thickness after 20 sec.

The permeability χ of the resulting inventive chromatographic membrane was determined as described in scientific publication Ley et. al, Journal of Membrane Science, Volume 564, 2018, Pages 543-551 (page 547: description; page 545: measurement). The permeability at 100 mbar trans membrane pressure (TMP) of a single layer inventive chromatographic membrane was compared to the permeability of a stack of 3 layers of inventive chromatographic membrane at a TMP of 100 mbar. The permeabilities are normalized to the different thicknesses by the following calculation:

$$χ [ mD ] = v * \frac{1 {0}^{- 6}}{1 {0}^{- 4} * 1 {0}^{5} * 60} * Δ x * 1 {0}^{- 6} * μ * 1 {0}^{- 3} * \frac{1}{9.869 * 1 {0}^{- 13}} * 1 {0}^{3}$$

Here, ν is the flow rate of water passing through the membrane single layer or stack

$$( in \frac{{cm}^{3}}{min * bar * {cm}^{2}} ) ,$$

μ the viscosity of water (in mPa·s) and Δx the single layer or stack thickness (in μm).

The relative permeability of inventive chromatographic membranes is calculated by

$$relative permeability [ \% ] = \frac{permeability 3 - layer membrane stack}{permeability single layer membrane} \cdot 100$$

TABLE 4

| | | Relative membrane | Relative membrane | Relative membrane |
|---|---|---|---|---|
| | | permeability of | permeability of | permeability of |
| | | stack of 3 layers | stack of 3 layers | stack of 3 layers |
| | | of inventive | of inventive | of inventive |
| | | chromatographic | chromatographic | chromatographic |
| | Compression | membrane at | membrane at | membrane at |
| | of third | 100 mbar [%] | 100 mbar [%] | 1000 mbar [%] |
| | inert phase | according to | according to | according to |
| | [%] | Sample 34 | Sample 35 | Sample 35 |
| Third inert phase A | 90 | 94 | 85 | 65 |
| Third inert phase B | 87 | 91 | 86 | 79 |
| Third inert phase C | 82 | 81 | 48 | 37 |

The compression of the third inert phase has a strong effect on the permeability of the inventive chromatographic membrane under typical operating TMPs. The higher the compression of the third inert phase, the higher is the relative permeability of a 3-layer stack of inventive chromatographic membrane under typical operating pressures.

### Example 8

### Performance Characteristics of the Inventive Chromatographic Membrane Functionalized with Affinity Protein A Ligand

A reinforced inventive chromatographic membrane (=Sample A) was generated according to Example 6, Sample no. 34, having a third inert phase C according to Example 7, being modified according to Example 1. The generated inventive chromatographic membrane Sample A exhibits the following material and performance characteristics: thickness of 280 μm, permeability of 66 mD, ligand density 19.8 g/L. Inventive chromatographic membrane Sample A was cut into circular coupons and assembled as a 4-layer circular membrane stack in a reusable filtration device with a polypropylene filter housing (filter table and filter cover) with luer lock connectors and mechanically supported by a stainless steel holder which forms a mechanically stable chromatographic unit out of the filter cover, membrane stack and the filter table. The frontal area of the membrane stack was 5 cm² and the thickness 1.12 mm, which resulted in a total membrane volume (MV) of 0.56 mL.

The dynamic binding capacity of the inventive chromatographic membrane device for a purified monoclonal antibody at different residence times was determined using an Äkta Avant 150 chromatography system (Cytiva, 28976337). Equilibration and wash buffers used in the performance characterization were made from phosphate buffered saline (0.1 M pH 7.4, conductivity 16 mS/cm); As an elution buffer, acetic acid at 0.1 M concentration at pH 2.9 was used. The monoclonal antibody (MW ˜140 kDa) was generated by CHO cell fermentation. Clarification of the fermentation broth was done by depth filtration (Sartoclear DL20 0.8 m² 29XDL20-FCC; Sartoclear DL90 0.8 m² 29XDL90-FCC) and sterile filtration through a 0.2 μm sterile filter capsule (Sartopore 2 XLG 30″ 5447307G3-SS). The antibody was purified by using a Protein A MabSelectSuRe column (MabSelectSuRe GE 17-5438; XK 50/20 GE). The load solution used for the performance characterization of the membrane was made from equilibration buffer containing 1 mg/mL of the purified antibody. The flow rates for the dynamic binding capacity determination were 1, 3, 5 and 10 MV/min, which corresponds to residence times of 0.1, 0.2, 0.3 and 1 min. The concentration of the antibody in the flow-through fraction was determined by an in-line UV detector at 280 nm with a known extinction coefficient of the antibody of 1.42. The dynamic binding capacity was calculated for a 10% breakthrough of load solution based on the UV signal (=DBC 10%; cf. FIG. 9).

A 0.4 mL unit Fibro HiTrap PrismA (Cytiva 17549856 lot 17103843) was used as a benchmark chromatographic material representing a state-of-the-art purely convective protein A affinity chromatography material, exhibiting no diffusive phase. The material is made from cellulose nano fibers, where the ligand is immobilized onto the surface of the fibers and therefor directly accessible by the convective flow through the fibrous material eliminating any relevant diffusional transport limitations.

A 1 mL MabSelectSure column (Cytiva, 11003493) was used as an additional benchmark material representing a state-of-the-art protein A affinity resin material. The resin is made from crosslinked agarose and has an average bead size of 85 μm (GE Instructions 71-5020-91 AC), representing the diffusive phase.

The two state-of-the-art protein A affinity materials and the inventive protein A chromatographic material were characterized with regard to their chromatographic performance. Data were determined as described before. Equilibration and wash buffers used in the performance characterization were made from phosphate buffered saline (0.1 M pH 7.4, conductivity 16 mS/cm). As an elution buffer, acetic acid at 0.1 M concentration at pH 2.9 was used. The monoclonal antibody (mAb) (MW 140 kDa) was generated by CHO cell fermentation. Clarification of the fermentation broth was achieved by depth filtration (Sartoclear DL20 0.8 m² 29XDL20-FCC; Sartoclear DL90 0.8 m² 29XDL90-FCC) and followed by sterile filtration through a 0.2 μm sterile filter capsule (Sartopore 2 XLG 30″ 5447307G3-SS). The antibody was purified by using a ProA MabSelectSuRe column (MabSelectSuRe GE 17-5438; XK 50/20 GE).

The load solution used for the performance characterization of the inventive chromatographic membrane was made from equilibration buffer containing 1 mg/mL of the purified mAb. The concentration of the mAb in the flow-through fraction was determined by an in-line UV detector at 280 nm with a known extinction coefficient of the antibody of 1.42. The dynamic binding capacity was calculated for a 10% breakthrough of load solution based on the UV signal (=DBC 10%).

As depicted in FIG. 10, the inventive chromatographic membrane shows a markedly higher DBC 10% vs. residence time performance than a state-of-the-art agarose resin material, enabling highly productive and fast processes for antibody capture. The dynamic binding performance is very similar to the state-of-the-art convective membrane material. For very short residence times (<0.2 min), the convective material shows slightly higher DBC 10% values.

### Example 9

### Low Fouling Propensity of the Inventive Chromatographic Membrane Compared to Purely Convective Material of Similar Binding Capacity

A reinforced inventive chromatographic membrane was generated according to Example 6, Sample No. 34, having a third inert phase C according to Example 7, being modified according to Example 1. The fouling propensity of a freshly prepared membrane, assembled into a 4-layer chromatographic device configuration as described in Example 8, was compared to the fouling propensity of an unused, purely convective benchmark material Fibro (Cytiva 17549856 lot 17103843), described in Example 8 in order to compare the fouling propensity of these different chromatographic materials. Multiple bind & elute cycles were performed using a clarified mAb feed stream produced from CHO cells as described in Example 8, observing the changing permeability of the materials indicated by observing the change of the trans-device pressure during the consecutive bind & elute cycles.

The antibody concentration in the feed stream was 2.8 mg/mL. Before executing the cycling experiment, the dynamic binding capacity of the used devices was determined with purified mAb as generated in Example 8. It is important to note that both materials have a similar binding capacity of around 40 mg/mL at a residence time of 0.2 min (cf. FIG. 10). The load of the cycling study was then set to 80% of the determined DBC 10% value. The different phases in the bind & elute cycle are the following: 1) equilibration with 8 MV equilibration buffer at 10 MV/min; 2) loading to 80% of DBC 10% with clarified feed stream at 5 MV/min (i.e. 7.5 mL load for Cytiva HiTrap 0.4 mL, and 6 mL load for the inventive chromatographic membrane); 3) washing with 8 MV wash buffer at 10 MV/min; 4) elution with 10 MV at 5 MV/min; and 5) washing with 5 MV wash buffer at 10 MV/min. Then the next cycle was started by equilibration (step 1), or a Cleaning-In-Place (CIP) step was performed before restarting, using 10 MV of 0.1 M sodium hydroxide at 3 MV/min, which results in a 3 min duration of one CIP step, followed by an additional wash step with equilibration buffer until pH 7.4 is reached using a flow rate of 10 MV/min.

The frequency of CIP steps was diminished as the cycling experiment was progressing in order to reduce the cleaning intensity of the CIP step. For the first 20 cycles, a CIP step was performed after each cycle. For the cycles number 21-40, a CIP step was performed only after every 5^{th} cycle. For cycle number 41-70, a CIP step was performed only after every 10^{th} cycle. For all further cycles starting from the 71^{st} cycle, no CIP step was performed anymore.

FIG. 11 shows the trans-device (delta) pressure as observed at each cycle during the equilibration phase at a flow rate of 10 MV/min for both devices.

First, it is important to realize that despite the very similar configuration of both materials (bed height is for both materials approx. 1 mm) the trans-device pressure at the same flow rate of 10 MV/min is much higher for the convective material (approx. 0.07 MPa) compared to the inventive chromatographic membrane (0.01 MPa). This is due to the smaller pore size observed for the convective Fibro material from Cytiva that is a prerequisite for attaining a binding capacity similar to the binding capacity of the inventive chromatographic membrane.

The convective Fibro material from Cytiva shows stable trans-device pressure during the first 20 cycles, were a CIP step followed after each bind & elute cycle. However, as the CIP frequency was reduced after cycle 21^{st} to a CIP step only after every 5^{th} cycle, the Fibro material starts to exhibit rapidly increasing trans-device pressures. At the 31^{st} cycle, the trans-device pressure reaches 0.76 MPa, which well exceeds typical processing pressures of up to 0.4 MPa in related industrial applications of such materials.

The inventive chromatographic membrane Sample A shows a different behavior regarding the trans-device pressure development over the consecutive cycles: The trans-device pressure remains at the low level of 0.01 MPa for almost 79 cycles, despite the fact that the CIP frequency was continuously reduced during the 79 cycles until no CIP step was performed anymore after the 70^{th} cycle. Slow increase in trans-device pressure is observed starting after the 79^{th} cycle, reaching approx. MPa at cycle 150. This behavior is markedly different for those two materials despite the fact that the binding capacity is on the same level.

The data clearly shows the markedly different fouling propensity of the two separation materials. This behavior is most likely due to the significantly larger convective pore size of the inventive chromatographic membrane (approx. 4 μm) compared to the purely convective cellulose fiber based membrane material (approx. 0.4 μm).

### Example 10

### Integration into a Scalable Device Family

Inventive chromatographic membrane Sample A (cf. Example 8) was manufactured in roll format using a continuous coating process where the emulsion is coated onto the third inert phase. The emulsion is cooled down below the gelling point in order to form a continuous roll of membrane.

The inventive chromatographic membrane roll material containing surfactants and solvent is extracted by a continuous extraction and washing process using alcohol and water. Subsequently the roll material is crosslinked and simultaneously activated by impregnation with a bisoxirane solution containing sodium hydroxide. After washing in a continuous washing process, coupling of Protein A is performed in a jigger by winding the activated membrane roll between two winding rolls, thereby passing the reaction solution containing Protein A (10 mg/mL) dissolved in phosphate buffer (1 M, pH8.5). Subsequently, the Protein A membrane is dried from a humectant in a continuous rinsing/drying process to yield a Protein A membrane in roll format.

From these membrane rolls, spiral-wound chromatography modules with three different bed volumes at constant bed height could be generated. By changing the number of layers of the stacked inventive chromatographic membrane, various bed volumes and bed dimensions can be established based on targeted values like permeability, binding capacity or axial dispersion. In these modules, the membrane was rolled together with a spacer fleece in an alternating fashion.

Membrane layers were connected in a fluid-tight fashion to the housing by a melt process. Edges of the membrane bed were sealed in a previous step before integration into the respective housings. An impinging flow channel is given upstream from the membrane bed to the inlet and an outflow channel is given downstream from the outlet.

Table 5 shows the characteristics of the three modules differing in bed volume from 1.2 to 70 mL, which corresponds to a scaling factor of 58.3. The bed height is kept constant at 4 mm, ensuring almost identical permeability for all three modules of 7.6-8.3 MV/min*bar despite the different bed volumes.

Using state-of-the-art chromatographic systems, a single chromatographic bind & elute cycle of a clarified mAb feed stream was run as described in Example 9 with each of the three modules in order to evaluate the level of similarity of the chromatographic performance. For the 1.2 mL Nano device an Äkta 150 Avant system was used as described in Example 8. For the 10 mL Mini Capsule and the 70 mL 5-Inch Capsule, a multi-use Membrane Chromatography system (Sartorius, MCSCEB46NAK) was employed. The system is a liquid chromatography system intended for production and process development consisting of a configuration for the implementation of membrane chromatography based on Rapid Cycling Chromatography (RCC).

The generated UV chromatograms of the respective bind & elute cycles, normalized to the membrane volume permeated through the respective module (x-Axis), are depicted in FIG. 12. The chromatograms of the three devices are almost identical, which is a strong indication for a scalable performance, i.e. very similar chromatographic performance despite the wide range of module sizes, i.e. the wide range of bed volumes employed.

TABLE 5
Characteristics of the employed chromatography modules

| | Nano | Mini | 5 Inch |
|---|---|---|---|
| | Capsule | Capsule | Capsule |
| Bed volume [mL] | 1.2 | 10 | 70 |
| Bed height [mm] | 4 | 4 | 4 |
| Permeability [MV/min*bar] | 7.6 | 8.1 | 8.3 |
| Elution volume [mL] | 5.0 | 5.3 | 5.3 |

### Example 11

### Robust Cycling Behavior for Different Feed Streams

In order to demonstrate the versatility and broad applicability of the inventive chromatographic membrane, three different clarified mAb fermentation broths that contained three different mAbs were purified in a rapid cycling process with a reinforced inventive chromatographic membrane, generated according to Example 6, Sample No. 34, having a third inert phase A according to Example 7, being modified according to Example 1. The inventive chromatographic membrane was integrated into a downscale device with 1.2 mL bed volume as described in Example 10. For each cycling study with 200 cycles a fresh device was used.

Table 6 gives an overview of the performed cycling study for the three different monoclonal antibodies. After equilibration, the device was loaded with feed to 80% of the earlier determined DBC 10% value, followed by a wash, the elution of the mAb, a CIP cycle and the re-equilibration. In column 3 of Table 6, the applied volumes for the different steps are indicated. For the CIP cycle, the volume was variable, as the device was flushed with 0.2 M NaOH until the pH of the effluent of the device reached pH 12.5 and flushing another 3.3 MV after reaching this pH value. Also for the Re-equilibration step, the applied PBS buffer volume was variable, as the device was flushed until the effluent reached a pH of 7.5. During all cycling studies an inline pre filtration of the feed was performed by using a Sartopore2 XLG 0.8/0.2 μm (5441307G4-SS, 210 cm²), connected between sample pump and injection valve.

Cycling at an Äkta avant 150 chromatography system:

TABLE 6
Cycling method

| | | volume | | time |
|---|---|---|---|---|
| step | | [MV] | MV/min | [min] |
| equilibration | 1x PBS pH 7.4 | 4.16 | 8.33 | 0.5 |
| Feed ~80% | mAb A (3.1 mg/ml) | 8.75 | 4.16 | 2 |
| of DBC 10% | mAb B (4.3 mg/ml) | 7.5 | | 2 |
| | mAb C (2.3 mg/ml) | 10 | | 1.2 |
| | | 12.1 | | 3 |
| wash | 1x PBS pH 7.4 | 8.33 | 8.33 | 1.2 |
| elution | 0.1M Acetate pH 2.9 + | 8.33 | 4.16 | 2.4 |
| | 150 mM sodium chloride | | | |
| CIP each cycle | 0.2M NaOH | until pH >12.5 + | 4.16 | ~2 |
| | | 3.3 MV (~10 MV) | | |
| Re equilibration | 1x PBS pH 7.4 | until pH 7.5 (~21 MV) | 8.33 | ~2.5 |

FIGS. 13, 14, and 15 show the overlayed UV chromatograms of the respective 200 cycles for each antibody as a function of permeated volume. All three chromatograms show very similar and consistent behavior over all 200 cycles, indicating that the inventive chromatographic membrane did not change its characteristics or performance over the course of the cycling study. This can also be seen from FIGS. 16, 17, and 18 showing the overlayed trans-device pressures of the respective 200 cycles for each antibody/cycling study respectively. All three pressure traces show very similar and consistent behavior over all 200 cycles, again, indicating that the inventive chromatographic membrane did not change its characteristics or performance over the course of the cycling study. A slight decrease in pressure can be observed over the course of the 200 cycles. This drop in trans-device pressure can be attributed to a slow heat-up of the feed solution from 4° C. in the beginning of the scaling study to room temperature during the study decreasing the viscosity of the feed solution and therefore generating a reduced trans-device pressure.

The elution peaks (second peak in the UV chromatograms, starting at 30-35 mL volume) were fractionated from 100 mAu (first time signal surpasses this threshold) −100 mAu (signal falls below this threshold), and yield, elution volume, elution concentration, contaminant removal (HCP, DNA, aggregates) as well as levels of leached ProA ligand were determined. The methods for detection of yield, elution concentration and aggregates are size exclusion chromatography with a Yarra SEC 3000 column from Phenomenex, using a HPLC system of Thermo fisher scientific. HCP analyses were carried out with HCP ELISA Cygnus technologies F #550 3^{rd} generation. DNA was analysed by using PICOGREEN assay P11496. ProA ligand concentration in the eluate fraction was detected with an ELISA of Repligen 9000/1, however, only for mAb A eluate fractions.

FIGS. 19 to 25 show the data sets for mAb A, mAb B and mAb C. It becomes apparent that all relevant process characteristics (yield, HCP removal, DNA removal, ProA ligand leaching, elution peak width, pool concentration, aggregate concentration) stayed at a constant level over the course of the 200 cycles for all three mAbs. This confirms the stable performance behavior of all three devices for different mAbs and respective feedstreams, despite the fact that only one generic cycling recipe was utilized. These results show the very robust and feed stream independent behavior of the inventive chromatographic membrane.

### Example 12

### High Chromatographic Performance Due to High Bed Heights

A reinforced inventive chromatographic membrane was generated according to Example 6, Sample No. 34, having a third inert phase B according to Example 7, being modified according to Example 1. In order to demonstrate the effect of bed height on chromatographic performance, the generated inventive chromatographic membrane was built into a chromatographic device with two different bed heights by stacking different number of membrane layers into the device, namely 3 and 12 layers. The flow distribution in front of the chromatographic bed as well as after the chromatographic bed was identical for both devices, independent of the bed height. The two chromatographic devices, only differentiated by the number of integrated inventive chromatographic membrane layers, had the following characteristics:

TABLE 7

| | Bed | Trans-device pressure |
|---|---|---|
| | height | drop at 5 MV/min |
| 3 layers | 0.78 mm | 0.007 MPa |
| 12 layers | 3.1 mm | 0.043 MPa |

The chromatograms in FIGS. 26 and 27 show the different chromatographic behavior of the device differing only in bed height. Both the breakthrough curve and the elution peak show marked differences. For the low bed height device with only 3 layers of inventive chromatographic membrane, early breakthrough, a slow increase of the breakthrough curve and a wide elution peak can be seen, whereas for the high bed height device with 12 layers of inventive chromatographic membrane, late breakthrough with a relatively sharp increase of the breakthrough and a narrow elution peak are observed. These effects lead to higher binding capacity and faster elution, resulting in higher productivity, lower buffer consumption, and higher elution pool concentration. These effects can be attributed to the improved chromatographic behavior of the device with the higher bed height, due to lower axial dispersion.

### Example 13

### Materials and Performance Characteristics for Inventive Chromatographic Membranes Functionalized with Cation-Exchange or Mixed Mode Ligands

In order to demonstrate the versatility and platform character of the inventive chromatographic membrane, different functional groups were immobilized onto an inventive chromatographic membrane generated according to Example 6, Sample Nos. 34 and 35, described in the above-described general preparation example.

### CIEX Functionalization:

CIEX ligand functionalization was carried out in a two-step process. In a first step, the activation of the inventive chromatographic membrane according to Example 6, Sample No. 35 is carried out with a bisoxirane molecule so that at least one oxirane group of the bisoxirane reacts with the membrane to enhance the mechanical stability of the matrix material. The second step is carried out by adding the ligand to the activated inventive chromatographic membrane at a basic pH. For this example, 3-bromopropanesulfonate (3-BPS) was immobilized onto the inventive chromatographic membrane with a concentration of the reaction solution of 20 wt % at pH=14 over a 24 hour period. Table 8 lists the properties of the generated cation ion exchange membrane.

TABLE 8

| | | | Membrane | | | SBC |
|---|---|---|---|---|---|---|
| | | | volume in | | Ligand | (γ- |
| Sample | Functiona- | Thickness | device | Permeability | density | globulin) |
| No. | lization | [μm] | [mL] | [mD] | [μmol/mL] | [mg/ml] |
| 36 | CIEX | 260 | 0.52 | 297 | 92.6 | 79.4 |

In order to characterize the bind & elute performance of the CIEX functionalized inventive chromatographic membrane generated according to Example 13, sample No. 36, the membrane was assembled as a 4-layer membrane stack in a reusable filtration device with PP filter housing (filter table and filter cover) and stainless-steel holder as described in Example 8.

DBC 10% values of the inventive chromatographic membrane were determined at various flow rates to obtain different residence times (RT) of the target protein γ-globulin (Sigma-Aldrich, G5009) according to the method described in Example 1. The target protein γ-globulin (0.88 g/mL) was loaded onto the inventive chromatographic membrane in binding buffer conditions (sodium acetate, 20 mM, pH=5, 1.5 mS/cm) at flow rates of 15, 10, 7,5, 5, 2.5 and 1 MV/min, which result in residence times of 4, 6, 8, 12, 24 and 60 s. Sartobind S (Sartorius catalog, 96IEXS42EUC11-A) was examined under the same conditions, representing a state-of-the-art membrane material.

As a benchmark material representing a state-of-the-art CIEX resin material a 1 mL HiTrap Capto S® column (Cytiva catalog, 29400458) was purchased from Cytiva®.

The resins have an average bead size of 90 μm, representing the diffusive phase. The column filled with Capto S® resins was characterized with regard to the chromatographic performance, by determining the DBC 10% value for γ-globulin (4.74 g/mL) in the same binding buffer conditions at flow rates of 5, 1, 0.5 and 0.2 MV/min which is equivalent to residence times of 0.2, 1, 2 and 5 min as described above for the membrane material.

FIG. 28 shows the DBC 10% results as a function of the residence time for the CIEX materials.

The results show an increase in DBC 10% of 47% for the inventive chromatographic CIEX membrane in comparison to the respective state-of-the-art resin, and of 62% compared to the state-of-the-art membrane while having applied a 90% shorter or the same residence time of the target molecule in the chromatographic material, respectively.

### Mixed-Mode (MM) Functionalization:

Ligand immobilization for a mixed mode ligand with a permanent positive charge was conducted on an inventive chromatographic membrane generated according to Example 6, Sample No. 34. Activation using a bisoxirane molecule according to the above-described general preparation example was followed by allylation with allylic bromide (20 wt %, 2 mol/L NaOH, 24 h). Bromination and the final coupling of the ligand (N-Benzyl-N-methylethanolamine, BMEA) were conducted according to U.S. Pat. No. 8,895,710 B2.

The inventive chromatographic MM membrane was characterized with respect to ligand density, SBC and DBC 10% according to Example 1.

Ligand density for the inventive chromatographic MM membrane was determined according to CIEX material titration with HCl as known to persons skilled in the art. SBC was determined with γ-globulin as target (3 mg/mL) in binding buffer conditions (Glycin-NaOH, 20 mM, pH=8, 40 μS/cm). The elution step after washing was conducted in elution condition buffer (Glycin-HCl, 20 mM, pH=2.5, 2.1 mS/cm).

Results of the characterization of the inventive chromatographic MM membrane are indicated in Table 9.

TABLE 9

| | | | Number of | | | | |
|---|---|---|---|---|---|---|---|
| | | | layers in | Membrane | | | |
| | | | membrane | volume in | | Ligand | SBC (γ- |
| Sample | Functiona- | Thickness | stack | device | Permeability | density | globulin) |
| No. | lization | [μm] | [—] | [mL] | [mD] | [μmol/mL] | [mg/ml] |
| 37 | MM | 250 | 4 | 0.50 | 130 | 75 | 99 |

In this Example, the inventive chromatographic membrane according to Example 13, Sample No. 37, were assembled as a membrane stack in a reusable filtration device with PP filter housing (filter table and filter cover) and stainless steel holder and characterized with respect to the methods described in Example 1.

Determination of DBC 10% was conducted with γ-globulin as target (1 mg/mL) and with conditions used for SBC determination. DBC 10% values were determined at various flow rates to obtain different residence times (RT) of the target molecule in the chromatographic material. The flow rates have been adjusted to 1, 5, 10 and 20 MV/min, which corresponds to residence times of 1.0, 0.2, 0.1 and 0.05 min.

A 1 mL HiTrap Capto Adhere column was purchased from Cytiva (Cytiva catalog, 28405844) and used as a benchmark material representing state of the art mixed-mode resin material. The resin has an average bead size of 75 μm, representing the diffusive phase. This state-of-the-art mixed-mode resin material was characterized with regard to the chromatographic performance, by determining the 10% DBC value for a γ-globulin (Sigma-Aldrich, catalog G5009) at residence times of 2 and 4 min which is equivalent to a flow rate of 2 and 4 MV/min as described above for the CIEX-membrane.

The results of DBC 10% as function of residence time are depicted in FIG. 29. The results show an increase in DBC 10% of 280% for the inventive chromatographic MM membrane in comparison to the respective state-of-the-art MM resin while having applied a 95% shorter residence time of the target molecule in the inventive chromatographic MM membrane.

The performance data with the different ligands shows the versatility of the inventive chromatographic membrane, and its applicability for different chromatographic tasks. Due to the ease of functionalization of polysaccharids, a broad variety of functional ligands can be immobilized to the inventive chromatographic membrane, generating respective chromatographic materials.

1. A chromatographic material comprising a polymer network material-based self-supporting bi-continuous separation matrix comprising a first continuous phase and a second continuous phase, the chromatographic material optionally comprising a third inert phase, wherein the first continuous phase is a portion of the matrix which is formed by a self-gelled polysaccharide and wherein the second continuous phase is a portion of the matrix which defines non-cylindrical large diameter continuously connected convective pores in-between the first continuous phase, wherein the non-cylindrical large diameter continuously connected convective pores have a median pore diameter of from 0.1 μm to 6.0 μm, and wherein the third inert phase does not constitute the structure of the second continuous phase.

2. The chromatographic material according to claim 1, wherein the self-gelled polysaccharide is one or more selected from the group consisting of agarose, agar, agaropectin, kappa-carrageenan, iota-carrageenan, lambda-carrageenan, gellan gum, amylose, curdlan, alginate and rhamsan gum.

3. The chromatographic material according to claim 1, wherein a median bridge diameter of the first continuous phase is from 0.4 to 4 times larger than the median pore diameter of the non-cylindrical large diameter continuously connected convective pores.

4. The chromatographic material according to claim 1, wherein when a convective porosity ε is a ratio of a volume of the second continuous phase to a total volume of the first and second continuous phase, the convective porosity ε is from 0.05 to 0.7.

5. The chromatographic material according to claim 1, which has a permeability of at least 0.31×(ε×100) mD, wherein ε is a convective porosity.

6. The chromatographic material according to claim 1, wherein a coefficient of variance of the median pore diameter of the non-cylindrical large diameter continuously connected convective pores is at most 0.8.

7. The chromatographic material according to claim 1, wherein a coefficient of variance of a median bridge diameter of the first continuous phase is at most 0.7.

8. The chromatographic material according to claim 1, further comprising the third inert phase.

9. The chromatographic material according to claim 8, wherein a compressibility of the third inert phase is at least 85%, as determined according to the method indicated in the description.

10. The chromatographic material according to claim 8, wherein a ratio of a volume of the third inert phase to a total volume of the chromatographic material including the third inert phase is from 0.03 to 0.60.

11. A method of producing the chromatographic material according to claim 1, the method comprising:
(a) preparing a solution (A) comprising a self-gelling polysaccharide and a first solvent;
(b) preparing a solution (B) comprising at least one surfactant and a second solvent which is an immiscible solvent to solution (A);
(c) combining the solution (A) and the solution (B) to produce a combined solution (C);
(d) emulsifying the combined solution (C) at a condition to allow the self-gelling polysaccharide to remain in solution in the first solvent as solution (A) to obtain an emulsion which is in form of a solution (B)-in-solution (A)-emulsion; and
(e) allowing the solution (A) containing the self-gelling polysaccharide to solidify by gelation at a certain condition to form the chromatographic material which comprises the separation matrix comprising the self-gelled polysaccharide as the first continuous phase.

12. The method according to claim 11 in which the self-gelling polysaccharide is agarose, the method comprising:
(a) preparing the solution (A) comprising agarose and water by heating an agarose-in-water-suspension to at least 90° C. for at least 15 minutes to solve the agarose in the water;
(b) preparing the solution (B) comprising the at least one surfactant and the second solvent which is a water-immiscible organic solvent and heating solution (B) to a temperature above a gelation temperature of the used agarose;
(c) combining the solution (A) and the solution (B) at a temperature of above the gelation temperature of the used agarose to produce a combined solution (C);
(d) emulsifying the combined solution (C) at a temperature above the gelation temperature of the used agarose to allow the agarose to remain in solution in the first solvent as solution (A) to obtain an emulsion which is in form of a solution (B)-in-solution (A)-emulsion; and
(e) allowing the solution (A) containing the self-gelling agarose to solidify by gelation at a temperature below the gelation temperature of the used agarose to form the chromatographic material which comprises the separation matrix comprising the self-gelled agarose as the first continuous phase.

13. The method according to claim 11, wherein the at least one surfactant has an HLB value of from 8 to 16.

14. The method according to claim 11, wherein the second solvent is one or more selected from C₄₋₁₂ alcohols, C₄₋₁₂ isoalcohols, alkanes, silicone oils having a viscosity of from 4 to 200 cP, natural oils having a viscosity of from 4 to 200 cP, and mixtures thereof.

15. The method according to claim 11, wherein the at least one surfactant is selected from polysorbates and/or C₂₋₁₅₀ fatty acid esters of sorbitol.

16. The method according to claim 11, wherein the concentration of the polysaccharide in the solution (A) is from 0.5 to 8 wt %.

17. The method according to claim 11, wherein a volume ratio of the second solvent in the combined solution (C) in (c) is from 10 to 70 vol %.

18. The method according to claim 11, wherein (e) is performed by pouring the emulsion on a casting form and cooling the emulsion below the gelling point.
